(19) United States
(12) Patent Application Publication
(10) Pub. No.: US 2025/0215936 A1
(43) Pub. Date: Jul. 3, 2025

(54) CLUTCH DEVICE

(71) Applicant: DENSO CORPORATION, Kariya-city (JP)

(72) Inventor: Tomonori SUZUKI, Kariya-city (JP)

(21) Appl. No.: 19/083,911

(22) Filed: Mar. 19, 2025

Related U.S. Application Data
(63) Continuation of application No. PCT/JP2023/033955, filed on Sep. 19, 2023.

(30) Foreign Application Priority Data
Sep. 22, 2022 (JP) 2022-151720

(51) Int. Cl. F16D 28/00; F16D 11/14; F16D 23/14

(52) U.S. Cl. CPC F16D 28/00; F16D 11/14; F16D 23/14; F16D 2023/141

(57) ABSTRACT

A fork base is provided radially outward of a nut, and is movable in an axial direction relative to the nut. A movement restriction portion restricts relative movement of the fork base in the axial direction relative to the nut. An electric actuator unit includes a spring provided between the nut and the fork base to bias the fork base in the axial direction relative to the nut. A control unit controls an operation of a rotary electric motor to move a dog clutch to a position where the dog clutch starts to come into contact with a first transmission unit. A load of the spring is set such that, after the dog clutch and the first transmission unit start to come into contact with each other, the dog clutch and the first transmission unit are meshed with each other under the load of the spring.

### CROSS REFERENCE TO RELATED APPLICATIONS

The present application is a continuation application of International Patent Application No. PCT/JP2023/033955 filed on Sep. 19, 2023, which designated the U.S. and claims the benefit of priority from Japanese Patent Application No. 2022-151720 filed on Sep. 22, 2022. The disclosures of all the above applications are incorporated herein.

### TECHNICAL FIELD

The present disclosure relates to a clutch device.

### BACKGROUND ART

In the related art, there is a clutch device capable of allowing or interrupting transmission of torque between a first transmission unit and a second transmission unit that are rotatable relative to each other.

### SUMMARY

A clutch device according to the present disclosure includes an electric actuator unit and a clutch unit. The electric actuator unit includes a rotary electric motor, a rotational translation unit and a fork. The rotational translation unit is configured to convert rotational motion caused by torque from the rotary electric motor into translational motion. The fork is configured to be translated by the translational motion of the rotational translation unit. The clutch unit includes a first transmission unit, a second transmission unit and a dog clutch. The second transmission unit is rotatable relative to the first transmission unit. The dog clutch is configured to translate with translation of the fork and mesh with the first transmission unit to allow transmission of torque between the first transmission unit and the second transmission unit. The rotational translation unit includes a shaft and a nut. The shaft is configured to rotate when receiving torque from the rotary electric motor. The nut has an annular or tubular shape, is provided radially outward of the shaft, and is configured to translate in an axial direction relative to the shaft in accordance with rotation of the shaft. The fork includes a fork base and a movement restriction portion. The fork base has an annular or tubular shape, is provided radially outward of the nut and movable in the axial direction relative to the nut. The movement restriction portion is configured to restrict relative movement of the fork base in the axial direction relative to the nut. The electric actuator unit includes a spring provided between the nut and the fork base and configured to bias the fork base in the axial direction relative to the nut.

### BRIEF DESCRIPTION OF DRAWINGS

The above object and other objects, features, and advantages of the present disclosure will become more apparent from the following detailed description with reference to the accompanying drawings. In the drawings:

FIG. 1 is a schematic diagram showing a clutch device according to a first embodiment and a vehicle to which the clutch device is applied;

FIG. 2 is a cross-sectional view showing the clutch device according to the first embodiment;

FIG. 3 is a cross-sectional view showing an electric actuator unit of the clutch device according to the first embodiment;

FIG. 4 is a cross-sectional view showing a clutch unit of the clutch device according to the first embodiment;

FIG. 5 is an exploded perspective view showing the clutch device according to the first embodiment;

FIG. 6 is a schematic diagram showing an operation state of the clutch device according to the first embodiment;

FIG. 7 is a schematic diagram showing an operation state of the clutch device according to the first embodiment;

FIG. 8 is a schematic diagram showing an operation state of the clutch device according to the first embodiment;

FIG. 9 is a schematic diagram showing an operation state of the clutch device according to the first embodiment;

FIG. 10 is a schematic diagram showing an operation state of a clutch device according to a comparative embodiment;

FIG. 11 is a schematic diagram showing an operation state of the clutch device according to the first embodiment;

FIG. 12 is a schematic diagram showing an operation state of the clutch device according to the comparative embodiment;

FIG. 13 is a schematic diagram showing an operation state of the clutch device according to the first embodiment;

FIG. 14 is a diagram showing an operation example of the clutch device according to the first embodiment;

FIG. 15 is a cross-sectional view showing a clutch device according to a second embodiment;

FIG. 16 is a cross-sectional view showing a clutch device according to a third embodiment;

FIG. 17 is a cross-sectional view showing a clutch device according to a fourth embodiment;

FIG. 18 is a cross-sectional view showing a part of the clutch device according to the fourth embodiment;

FIG. 19 is a cross-sectional view showing a part of the clutch device according to the fourth embodiment; and

FIG. 20 is a cross-sectional view showing a part of the clutch device according to the fourth embodiment.

### DETAILED DESCRIPTION

A clutch device of a comparative example is provided in a vehicle, and is used to allow or interrupt transmission of torque between an input shaft connected to a first transmission unit and an output shaft connected to a second transmission unit. In the clutch device according to the comparative example, when a clutch sleeve moves to the first transmission unit and internal teeth of the clutch sleeve mesh with external teeth of the first transmission unit, transmission of torque between the first transmission unit and the second transmission unit is allowed.

In the clutch device according to the comparative example, the clutch sleeve is movable in translation, that is, in an axial direction, with translation of a fork. A waiting damper is provided between a translation member that translates by being driven by a rotary electric motor and the fork. The waiting damper includes a first spring sleeve and a second spring sleeve that are movable in the axial direction relative to the fork, and a waiting spring provided between the first spring sleeve and the second spring sleeve.

In the clutch device according to the comparative example, the waiting spring is used to prevent occurrence of a phenomenon in which it is difficult for the internal teeth of the clutch sleeve and the external teeth of the first transmission unit to mesh with each other due to a difference in rotational speed between the first transmission unit and the second transmission unit. However, in the clutch device according to the comparative example, when a load is reduced by waiting for a stroke of the translation member or the like while a frictional force is generated at the time of meshing between the internal teeth of the clutch sleeve and the external teeth of the first transmission unit, a meshing time between the internal teeth of the clutch sleeve and the external teeth of the first transmission unit may become long. Accordingly, responsiveness of the clutch device may decrease, which may affect traveling performance of a vehicle and the like.

In contrast, according to the present disclosure, a clutch device with high responsiveness can be provided.

A clutch device according to the present disclosure includes an electric actuator unit and a clutch unit. The electric actuator unit includes a rotary electric motor, a rotational translation unit and a fork. The rotational translation unit is configured to convert rotational motion caused by torque from the rotary electric motor into translational motion. The fork is configured to be translated by the translational motion of the rotational translation unit.

The clutch unit includes a first transmission unit, a second transmission unit and a dog clutch. The second transmission unit is rotatable relative to the first transmission unit. The dog clutch is configured to translate with the translation of the fork and mesh with the first transmission unit to allow transmission of torque between the first transmission unit and the second transmission unit.

The rotational translation unit includes a shaft and a nut. The shaft is configured to rotate when receiving torque from the rotary electric motor. The nut has an annular or tubular shape, is provided radially outward of the shaft, and is configured to translate in an axial direction relative to the shaft in accordance with rotation of the shaft.

The fork includes a fork base and a movement restriction portion. The fork base has an annular or tubular shape, is provided radially outward of the nut and movable in the axial direction relative to the nut. The movement restriction portion is configured to restrict relative movement of the fork base in the axial direction relative to the nut.

The electric actuator unit includes a spring provided between the nut and the fork base and configured to bias the fork base in the axial direction relative to the nut.

In the present disclosure, while a frictional force is generated at the time of meshing between a dog clutch and a first transmission unit, relative movement of a fork base in an axial direction with respect to a nut is restricted by a movement restriction portion, so that torque from a rotary electric motor can be transmitted to the dog clutch via the nut, the movement restriction portion, and a fork without passing through a spring. Accordingly, thrust equal to or greater than the frictional force can be applied from the rotary electric motor to the dog clutch, and a waiting time due to a meshing impact can be shortened. Accordingly, responsiveness of a clutch device can be enhanced.

The clutch device according to the present disclosure includes a control unit. The control unit is configured to control operations of the rotary electric motor and the electric actuator unit by controlling energization of the rotary electric motor.

According to the present disclosure, the control unit is configured to control an operation of the rotary electric motor to move the dog clutch to a position where the dog clutch starts to come into contact with the first transmission unit. A load of the spring is set such that, after the dog clutch and the first transmission unit start to come into contact with each other, the dog clutch and the first transmission unit are meshed with each other under the load of the spring. As a result, power supplied to the rotary electric motor can be reduced, and power consumption of the clutch device can be reduced.

Hereinafter, clutch devices according to multiple embodiments will be described with reference to the drawings. In the multiple embodiments, substantially the same components are denoted by the same reference signs, and description thereof is omitted.

### First Embodiment

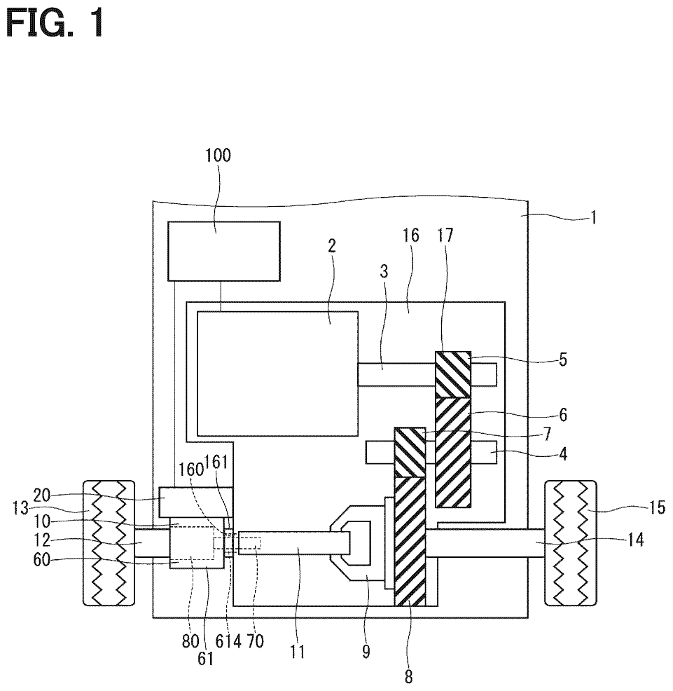

FIG. 1 shows a clutch device according to a first embodiment and a vehicle to which the clutch device is applied. A clutch device 10 is mounted on a vehicle 1 such as an electric vehicle.

The vehicle 1 includes a motor generator 2, a speed reducer 17, a differential 9, a differential shaft 11, an axle case 16, the clutch device 10, a wheel shaft 12, a wheel 13, a wheel shaft 14, a wheel 15, and an electronic control unit (hereinafter referred to as “ECU”) 100 as a “controller”.

The motor generator 2 is used as a drive source for traveling of the vehicle 1, and is capable of outputting torque by energization. The motor generator 2 is capable of generating electricity by a regenerative operation. The speed reducer 17 is capable of reducing the torque from the motor generator 2. The differential 9 is a differential device that distributes the torque from the speed reducer 17 to the wheels 13 and 15. The clutch device 10 is provided between the differential 9 and the wheel 13, and is used to allow or interrupt transmission of torque between the differential 9 and the wheel 13.

More specifically, the speed reducer 17 includes a first gear shaft 3, a second gear shaft 4, a first small-diameter gear 5, a first large-diameter gear 6, a second small-diameter gear 7, and a second large-diameter gear 8. The first gear shaft 3 is connected to the motor generator 2 and is rotatable integrally with rotation of the motor generator 2. The first small-diameter gear 5 is provided coaxially with the first gear shaft 3 so as to be rotatable integrally with the first gear shaft 3. The second gear shaft 4 is provided parallel to the first gear shaft 3. The first large-diameter gear 6 has an outer diameter larger than an outer diameter of the first small-diameter gear 5, is capable of meshing with the first small-diameter gear 5, and is provided coaxially with the second gear shaft 4 so as to be rotatable integrally with the second gear shaft 4. The second small-diameter gear 7 has an outer diameter smaller than the outer diameter of the first large-diameter gear 6, and is provided coaxially with the second gear shaft 4 so as to be rotatable integrally with the second gear shaft 4. The second large-diameter gear 8 has an outer diameter larger than the outer diameter of the second small-diameter gear 7, and is capable of meshing with the second small-diameter gear 7. With this configuration, the torque from the motor generator 2 is reduced by the speed reducer 17 and output from the second large-diameter gear 8.

“Coaxial” is not limited to a state in which both axes strictly coincide with each other, and includes a state in which both axes slightly intersect, a state in which both axes are substantially parallel to each other, and the like within a range of an error or the like or common technical knowledge (the same applies hereinafter).

The differential 9 is connected to the second large-diameter gear 8. One end of the differential shaft 11 is connected to the differential 9. The clutch device 10 is provided such that a first transmission unit 70 (described later) is connected to the other end of the differential shaft 11. A second transmission unit 80 (described later) of the clutch device 10 is connected to one end of the wheel shaft 12. The other end of the wheel shaft 12 is connected to the wheel 13. The wheel 13 is, for example, a wheel on a rear left side of the vehicle 1.

One end of the wheel shaft 14 is connected to the differential 9. The other end of the wheel shaft 14 is connected to the wheel 15. The wheel 15 is, for example, a wheel on a rear right side of the vehicle 1.

The axle case 16 is capable of accommodating, for example, the motor generator 2, the speed reducer 17, the differential 9, and the differential shaft 11, and is provided in the vehicle 1. The axle case 16 includes an axle case opening 160 and an axle case extension tubular portion 161. The axle case opening 160 is provided on an axis of the differential shaft 11 coaxially with the differential shaft 11 so as to connect a space inside the axle case 16 to an outside. The axle case extension tubular portion 161 extends in a tubular shape from the axle case opening 160.

According to the above-described configuration, when the clutch device 10 provides transmission of torque between the first transmission unit 70 connected to the differential shaft 11 and the second transmission unit 80 connected to the wheel shaft 12, transmission of torque between the motor generator 2 and the wheels 13 and 15 is allowed, the vehicle 1 is capable of traveling using the torque of the motor generator 2, and the motor generator 2 is capable of performing a regenerative operation.

The ECU 100 is a small computer including a CPU as an arithmetic unit, a ROM, a RAM, and the like as a storage unit, an I/O as an input and output unit, and the like. The ECU 100 executes calculation according to a program stored in the ROM or the like based on information such as signals from various sensors provided in each part of the vehicle 1, and controls operations of various devices and machines of the vehicle 1. In this way, the ECU 100 executes a program stored in a non-transitory tangible storage medium. By executing the program, a method corresponding to the program is executed.

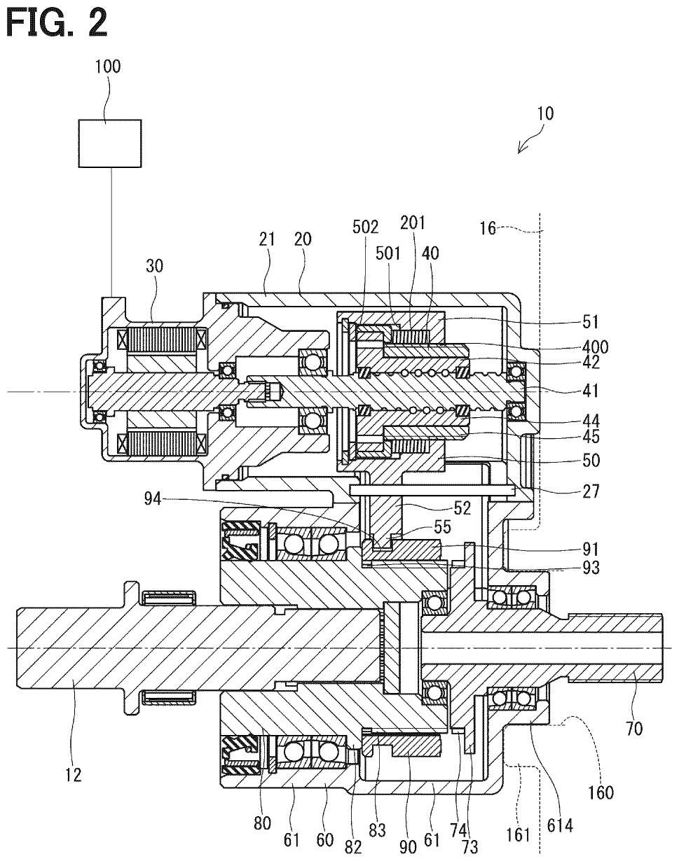

The ECU 100 is capable of controlling an operation of the motor generator 2 based on information such as signals from various sensors. The ECU 100 is capable of controlling the operation of the clutch device 10 by controlling an operation of a rotary electric motor 30 described later.

<1> As shown in FIG. 2, the clutch device 10 includes an electric actuator unit 20, a clutch unit 60, and the like. The electric actuator unit 20 includes the rotary electric motor 30, a rotational translation unit 40, and a fork 50. The rotational translation unit 40 is capable of converting rotational motion caused by torque from the rotary electric motor 30 into translational motion. The fork 50 can be translated by the translational motion of the rotational translation unit 40.

The clutch unit 60 includes the first transmission unit 70, the second transmission unit 80, and a dog clutch 90. The second transmission unit 80 is rotatable relative to the first transmission unit 70. The dog clutch 90 translates with translation of the fork 50 and meshes with the first transmission unit 70, thereby allowing transmission of torque between the first transmission unit 70 and the second transmission unit 80.

The rotational translation unit 40 includes a shaft 41 and a nut 42. The shaft 41 rotates when torque is input from the rotary electric motor 30. The tubular nut 42 is provided coaxially with the shaft 41 and radially outward of the shaft 41, and moves in an axial direction relative to the shaft 41 by translation when the shaft 41 rotates.

The fork 50 includes a fork base 51, a movement restriction portion 501, and a movement restriction portion 502. The tubular fork base 51 is provided radially outward of the nut 42 coaxially with the nut 42, and is movable in the axial direction relative to the nut 42. The movement restriction portion 501 and the movement restriction portion 502 are capable of restricting relative movement of the fork base 51 in the axial direction with respect to the nut 42.

The electric actuator unit 20 includes a spring 201 provided between the nut 42 and the fork base 51 and capable of biasing the fork base 51 in the axial direction relative to the nut 42.

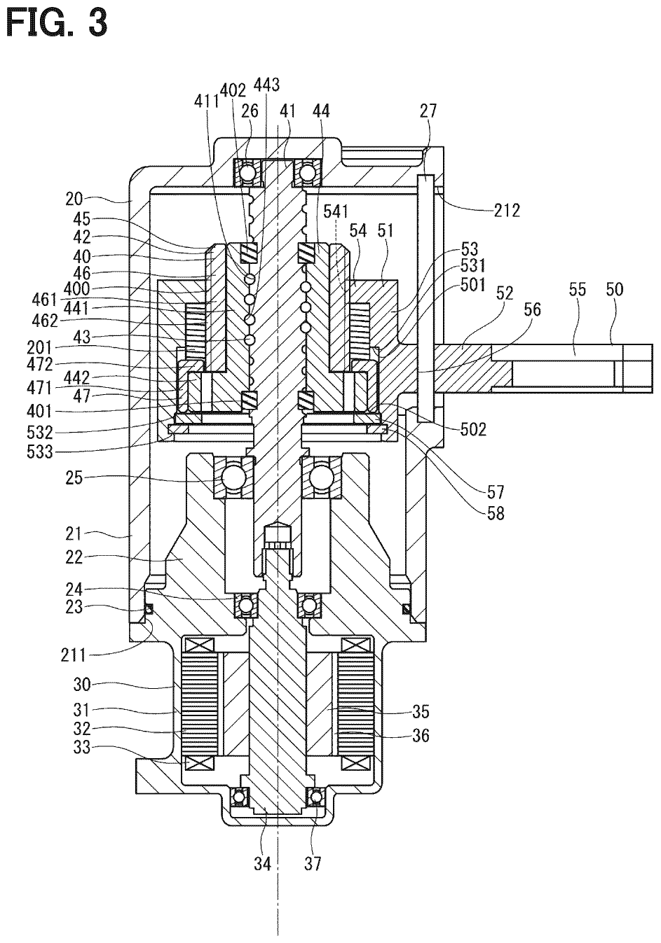

More specifically, as shown in FIG. 3, the electric actuator unit 20 includes an actuator case 21, a bearing portion 22, an O-ring 23, a bearing 24, a bearing 25, a bearing 26, and the like. The actuator case 21 is formed of, for example, metal in a tubular shape having a space therein. The actuator case 21 has an axial opening 211 and a radial opening 212. The axial opening 211 opens in the axial direction at one end portion of the actuator case 21 in the axial direction so as to connect a space inside the actuator case 21 to an outside. The radial opening 212 opens in a radial direction at the other end portion of the actuator case 21 in the axial direction so as to connect the space inside the actuator case 21 to the outside.

The bearing portion 22 is formed of, for example, metal in a tubular shape. One end portion of the bearing portion 22 in the axial direction is located in the space inside the actuator case 21, and an outer peripheral wall of the other end portion of the bearing portion 22 is fitted into the axial opening 211 of the actuator case 21. The O-ring 23 is formed of an elastic material such as rubber into an annular shape, and is provided between the other end portion of the bearing portion 22 in the axial direction and the axial opening 211. Accordingly, a space between the actuator case 21 and the bearing portion 22 is sealed to be airtight or liquid-tight.

The bearing 24, the bearing 25, and the bearing 26 are, for example, ball bearings. An outer peripheral wall of the bearing 24 is fitted to an inner peripheral wall of the other end portion of the bearing portion 22 in the axial direction. An outer peripheral wall of the bearing 25 is fitted to an inner peripheral wall of the one end portion of the bearing portion 22 in the axial direction. The bearing 26 is provided at an end portion of the actuator case 21 on the side opposite to the axial opening 211.

The rotary electric motor 30 includes a motor case 31, a stator 32, a coil 33, a motor shaft 34, a rotor 35, a magnet 36, and a bearing 37. The motor case 31 is formed of, for example, metal in a bottomed tubular shape, and is provided such that an end portion on an opening side is connected to the other end portion of the bearing portion 22 in the axial direction, and is coaxial with the bearing portion 22.

The stator 32 is formed of, for example, a magnetic material, such as a laminated steel plate in a tubular shape, and is fixed to the motor case 31 such that an outer peripheral wall of the stator 32 is fitted to an inner peripheral wall of the motor case 31. The coil 33 is wound around multiple teeth (not shown) that protrude radially inward of the stator 32. The motor shaft 34 is formed of, for example, metal in a substantially columnar rod shape, and one end portion of the motor shaft 34 in the axial direction is supported by the bearing 37 and the motor case 31, and the other end portion of the motor shaft 34 in the axial direction is supported by the bearing 24 and the bearing portion 22.

The rotor 35 is formed of, for example, a magnetic material, such as iron-based metal in a tubular shape, and an inner peripheral wall of the rotor 35 is fitted to an outer peripheral wall of the motor shaft 34, and is coaxial with the motor shaft 34. Accordingly, the rotor 35 is rotatable integrally with the motor shaft 34. The magnet 36 is provided on an outer peripheral wall of the rotor 35 so as to face teeth of the stator 32. Multiple magnets 36 are provided at equal intervals in a circumferential direction of the rotor 35 such that magnetic poles are alternately arranged.

The ECU 100 is capable of controlling an operation of the rotary electric motor 30 by controlling electric power supplied to the coil 33. When the electric power is supplied to the coil 33, a rotating magnetic field is generated in the stator 32, and the rotor 35 rotates. Accordingly, torque is output from the rotor 35 and the motor shaft 34. In this way, the rotary electric motor 30 includes the stator 32 and the rotor 35 provided rotatably relative to the stator 32, and is capable of outputting the torque from the rotor 35 by being supplied with electric power.

The rotor 35 is provided radially inward of the stator 32 so as to be rotatable relative to the stator 32. The rotary electric motor 30 is an inner rotor-type brushless DC motor.

The rotational translation unit 40 includes the shaft 41, the nut 42, balls 43, and the like. The shaft 41 is formed of, for example, metal in a substantially columnar rod shape, and one end portion of the shaft 41 is supported by the bearing 25 and the bearing portion 22, and the other end portion of the shaft 41 is supported by the bearing 26 and the actuator case 21. The shaft 41 has one end portion formed in a tubular shape and is connected to the other end portion of the motor shaft 34 in the axial direction by spline coupling. Accordingly, the shaft 41 rotates around an axis due to rotation of the rotary electric motor 30. A shaft ball thread groove 411 is provided between the bearing 25 and the bearing 26 on an outer peripheral wall of the shaft 41, extending in a spiral shape from the bearing 25 toward the bearing 26.

<4> The nut 42 includes a tubular inner nut portion 44 that moves in the axial direction relative to the shaft 41 when the shaft 41 rotates, and a tubular outer nut portion 45 provided radially outward of the inner nut portion 44 coaxially with the inner nut portion 44 so as to be non-rotatable relative to the inner nut portion 44 and movable and slidable in the axial direction relative to the fork base 51.

<2> The nut 42 includes a rotation restriction portion 400 capable of restricting relative rotation of the nut 42 with respect to the fork base 51.

More specifically, the inner nut portion 44 includes an inner nut tubular portion 441, an inner nut flange portion 442, and a nut ball thread groove 443. The inner nut tubular portion 441 is formed of, for example, metal in a substantially cylindrical shape. The inner nut flange portion 442 is integrally provided with the inner nut tubular portion 441 of the same material as that of the inner nut tubular portion 441 so as to extend radially outward from one end portion of the inner nut tubular portion 441. The nut ball thread groove 443 spirally extends on the inner peripheral wall of the inner nut tubular portion 441 from the inner nut flange portion 442 to the side opposite to the inner nut flange portion 442. The inner nut portion 44 is disposed between the bearing 25 and the bearing 26 such that the inner nut tubular portion 441 is located coaxially with the shaft 41 and radially outward of the shaft 41.

The outer nut portion 45 includes a first outer nut portion 46 and a second outer nut portion 47. The first outer nut portion 46 includes a first outer nut main body 461 and a nut external spline 462. The first outer nut main body 461 is formed of, for example, metal in a substantially cylindrical shape. The nut external spline 462 is integrally provided with the first outer nut main body 461 of the same material as that of the first outer nut main body 461 so as to protrude radially outward from an outer peripheral wall of the first outer nut main body 461 and extend linearly from one end portion to the other end portion in the axial direction. Multiple nut external splines 462 are provided at equal intervals in a circumferential direction of the first outer nut main body 461.

The first outer nut portion 46 is provided such that an inner peripheral wall of the first outer nut main body 461 is fitted to an outer peripheral wall of the inner nut tubular portion 441 and is non-rotatable relative to the inner nut portion 44. One end of the first outer nut portion 46 is capable of coming into contact with an inner edge portion of the inner nut flange portion 442.

The second outer nut portion 47 includes a second outer nut tubular portion 471 and a second outer nut plate portion 472. The second outer nut tubular portion 471 is formed of, for example, metal in a substantially cylindrical shape. The second outer nut plate portion 472 is integrally provided with the second outer nut tubular portion 471 of the same material as that of the second outer nut tubular portion 471 and is formed in an annular plate shape so as to extend radially inward from one end of the second outer nut tubular portion 471.

The second outer nut portion 47 is provided such that an inner peripheral wall of the second outer nut tubular portion 471 is fitted to an outer peripheral wall of the inner nut flange portion 442 and is non-rotatable relative to the inner nut portion 44. One end surface of the second outer nut plate portion 472 in the axial direction is capable of coming into contact with an outer edge portion of the inner nut flange portion 442.

The multiple balls 43 are provided between the shaft ball thread groove 411 of the shaft 41 and the nut ball thread groove 443 of the nut 42. The balls 43 are capable of rolling between the shaft ball thread groove 411 and the nut ball thread groove 443.

The rotational translation unit 40 includes an end cap 401 and an end cap 402. The end cap 401 and the end cap 402 are formed of, for example, an elastic material such as rubber in an annular shape. The end cap 401 is provided between an end portion of the inner nut tubular portion 441 on a bearing 25 side and the shaft 41. The end cap 402 is provided between an end portion of the inner nut tubular portion 441 on a bearing 26 side and the shaft 41.

The fork 50 includes the fork base 51, a fork extension portion 52, and a fork engagement portion 55. The fork base 51 includes a fork base tubular portion 53, a fork base plate portion 54, and a fork internal spline 541. The fork base tubular portion 53 is formed of, for example, metal in a substantially cylindrical shape. An inner diameter at one end portion of the fork base tubular portion 53 in the axial direction is larger than an inner diameter at the other end portion of the fork base tubular portion 53. Therefore, an annular and planar fork base step surface 531 is provided on an inner wall of the fork base tubular portion 53.

The fork base plate portion 54 is integrally provided with the fork base tubular portion 53 of the same material as that of the fork base tubular portion 53 and is formed in an annular plate shape so as to extend radially inward from the other end portion of the fork base tubular portions 53 in the axial direction. The fork internal spline 541 is integrally provided with the fork base plate portion 54 of the same material as that of the fork base plate portion 54 so as to protrude radially inward from an inner peripheral wall of the fork base plate portion 54 and extend linearly from one end portion to the other end portion in the axial direction. Multiple fork internal splines 541 are provided at equal intervals in a circumferential direction of the fork base plate portion 54.

The fork extension portion 52 is integrally provided with the fork base tubular portion 53 of the same material as that of the fork base tubular portion 53 and is formed in a plate shape so as to extend radially outward from an outer peripheral wall of the fork base tubular portion 53. A direction perpendicular to a plane direction of the fork extension portion 52 is parallel to the axial direction of the fork base tubular portion 53. The fork engagement portion 55 is integrally provided with the fork extension portion 52 of the same material as that of the fork extension portion 52 so as to extend from an end portion of the fork extension portion 52 on the side opposite to the fork base tubular portion 53. The fork engagement portion 55 is formed in a substantially semicircular shape when viewed in the axial direction of the fork base tubular portion 53. The fork engagement portion 55 is provided such that a center of the semicircular shape is connected to the fork extension portion 52.

The fork extension portion 52 is provided with a rotation prevention portion 56. The rotation prevention portion 56 is formed in a hole shape penetrating the fork extension portion 52 in a plate thickness direction.

The fork 50 is provided such that the fork base 51 is located coaxially with the nut 42 and radially outward of the nut 42, and the fork extension portion 52 is located on an inner side of the radial opening 212 of the actuator case 21. The nut 42 and the fork 50 are provided such that the nut external spline 462 and the fork internal spline 541 are spline-coupled. Accordingly, the nut 42 and the fork 50 are relatively movable in the axial direction and relatively non-rotatable in the circumferential direction.

The rotation restriction portion 400 is provided on the nut external spline 462 and, when engaged with the fork internal spline 541, is capable of restricting relative rotation of the nut 42 with respect to the fork base 51.

An annular and planar fork step surface 532 is provided on an inner wall of the end portion of the fork base tubular portion 53 on the side opposite to the fork base plate portion 54. A fork annular groove portion 533 is provided on the side opposite to the fork base plate portion 54 with respect to the fork step surface 532 of the fork base tubular portion 53, the fork annular groove portion 533 being annularly recessed radially outward from an inner peripheral wall.

An end portion of the fork base tubular portion 53 on the side opposite to the fork base plate portion 54 is provided with a washer 57. The washer 57 is formed of, for example, metal in an annular plate shape. The washer 57 is provided on an inner side of the fork base tubular portion 53 such that an outer edge portion of one end surface thereof is capable of coming into contact with the fork step surface 532. A C-ring 58 of the washer 57 is provided on the side opposite to the fork step surface 532. The C-ring 58 is formed of, for example, metal in a substantially C-shape. The C-ring 58 is provided on the fork base 51 so that an outer edge portion thereof enters the fork annular groove portion 533. Accordingly, the washer 57 is held between the fork step surface 532 and the C-ring 58, and is prevented from falling off the fork base 51.

An end portion on the second outer nut plate portion 472 of the second outer nut portion 47 of the nut 42 is capable of coming into contact with the fork base step surface 531. An end portion of the second outer nut portion 47 of the nut 42 on the side opposite to the second outer nut plate portion 472 and an outer edge portion of an end surface of the inner nut flange portion 442 on the side opposite to the second outer nut plate portion 472 are capable of coming into contact with the washer 57. Therefore, the nut 42 is relatively movable in the axial direction with respect to the fork base 51 of the fork 50 in a range from a position where the nut 42 is in contact with the fork base step surface 531 to a position where the nut 42 is in contact with the washer 57.

The movement restriction portion 501 is provided on the fork base step surface 531, and is capable of restricting relative movement of the fork base 51 with respect to the nut 42 toward the bearing portion 22 in the axial direction when coming into contact with the nut 42. The movement restriction portion 502 is provided in the washer 57, and is capable of restricting relative movement of the fork base 51 with respect to the nut 42 toward the side opposite to the bearing portion 22 in the axial direction when coming into contact with the nut 42.

When the outer nut portion 45 of the nut 42 and the fork base 51 of the fork 50 move relative to each other in the axial direction, the nut external spline 462 of the outer nut portion 45 and the fork internal spline 541 of the fork base 51 slide against each other, and an outer peripheral wall of the second outer nut tubular portion 471 of the outer nut portion 45 and an inner peripheral wall of the fork base tubular portion 53 of the fork base 51 slide against each other.

The electric actuator unit 20 includes a rotation prevention shaft 27. The rotation prevention shaft 27 is inserted into the rotation prevention portion 56 provided in the fork extension portion 52 and is provided in the actuator case 21 with both ends fixed to the radial opening 212. Accordingly, the fork 50 is allowed to move relative to the actuator case 21, the shaft 41, and the nut 42 in the axial direction, and is restricted from relative rotation with respect to the actuator case 21. The nut 42 is restricted in relative rotation with respect to the fork base 51 of the fork 50 by the rotation restriction portion 400.

The spring 201 is, for example, a coil spring formed by winding flat metal into a coil shape. The spring 201 is provided radially outside the first outer nut portion 46 and radially inside the fork base tubular portion 53, between the second outer nut plate portion 472 of the nut 42 and the fork base plate portion 54 of the fork base 51. One end of the spring 201 is in contact with the second outer nut plate portion 472. The other end of the spring 201 is in contact with the fork base plate portion 54. The spring 201 has a force extending in the axial direction. Accordingly, the spring 201 is capable of pressing the second outer nut portion 47 and the inner nut flange portion 442 against the washer 57 and biasing the fork base 51 in the axial direction against the nut 42.

According to the above-described configuration, when the rotary electric motor 30 rotates, the motor shaft 34 rotates and the shaft 41 rotates. Accordingly, the balls 43 roll between the shaft ball thread groove 411 and the nut ball thread groove 443. Since the rotation prevention shaft 27 restricts relative rotation of the fork 50 with respect to the actuator case 21 and the rotation restriction portion 400 restricts relative rotation of the nut 42 with respect to the fork 50, when the ball 43 rolls, the nut 42 moves relative to the shaft 41 in the axial direction.

When the nut 42 moves relative to the shaft 41 toward the side opposite to the bearing portion 22 in the axial direction, the fork 50 moves relative to the shaft 41 toward the side opposite to the bearing portion 22 in the axial direction due to a biasing force of the spring 201 until the nut 42 comes into contact with the movement restriction portion 501. When the nut 42 comes into contact with the movement restriction portion 501, the fork 50 moves relative to the shaft 41 toward the side opposite to the bearing portion 22 in the axial direction due to thrust of the nut 42, that is, thrust of the rotary electric motor 30.

On the other hand, when the nut 42 moves relative to the shaft 41 toward the bearing portion 22 in the axial direction, when the nut 42 comes into contact with the movement restriction portion 502, the fork 50 moves relative to the shaft 41 toward the bearing portion 22 in the axial direction due to the thrust of the nut 42, that is, the thrust of the rotary electric motor 30.

The ball 43 that rolls in the nut ball thread groove 443 and reaches an end portion of the nut ball thread groove 443 on an end cap 401 side or an end cap 402 side passes through a circulation member (not shown) and is returned to the end portion of the nut ball thread groove 443 on the end cap 402 side or the end cap 401 side.

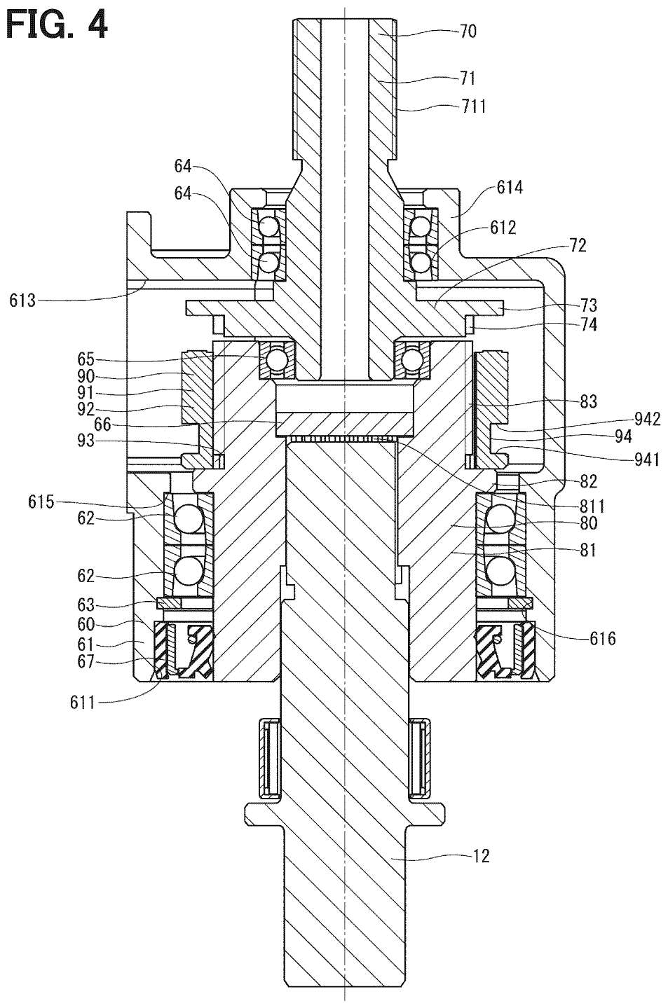

As shown in FIG. 4, the clutch unit 60 includes a clutch case 61, bearings 62, a C-ring 63, bearings 64, a bearing 65, a sealing member 66, an oil seal 67, and the like. The clutch case 61 is formed of, for example, metal in a tubular shape having a space therein. The clutch case 61 includes an axial opening 611, an axial opening 612, a radial opening 613, a clutch case extension tubular portion 614, a clutch case step surface 615, and a clutch case annular groove portion 616. The axial opening 611 opens in the axial direction at one end portion of the clutch case 61 in the axial direction so as to connect the space inside the clutch case 61 to an outside. The axial opening 612 opens in the axial direction at the other end portion of the clutch case 61 in the axial direction so as to connect the space inside the clutch case 61 to the outside. The radial opening 613 opens in the radial direction at the other end portion of the clutch case 61 in the axial direction so as to connect the space inside the clutch case 61 to the outside. The clutch case extension tubular portion 614 extends in a tubular shape in the axial direction of the clutch case 61 from the axial opening 612.

The clutch case step surface 615 is formed in an annular and planar shape at a center of an inner wall of the clutch case 61 in the axial direction. The clutch case annular groove portion 616 is annularly recessed radially outward from an inner peripheral wall on an axial opening 611 side with respect to the clutch case step surface 615 of the clutch case 61.

The bearing 62, the bearing 64, and the bearing 65 are, for example, ball bearings. An outer peripheral wall of the bearing 62 is fitted to an inner peripheral wall on an end portion side of the clutch case 61 on the axial opening 611 side. Two bearings 62 are provided side by side in the axial direction. One bearing 62 is provided such that an outer edge portion thereof is capable of coming into contact with the clutch case step surface 615. The number of bearings 62 is not limited to two, and only one bearing 62 may be provided.

The C-ring 63 is formed of, for example, metal in a substantially C-shape. The C-ring 63 is provided on the clutch case 61 such that an outer edge portion thereof enters the clutch case annular groove portion 616. The other bearing 62 is provided such that an outer edge portion thereof is capable of coming into contact with the C-ring 63. Accordingly, the two bearings 62 are held between the clutch case step surface 615 and the C-ring 63, and are prevented from falling off the clutch case 61.

<3> The first transmission unit 70 includes a first external spline 74 at an end portion on a second transmission unit 80 side. The second transmission unit 80 includes a second external spline 83 at an end portion on the first transmission unit 70 side. The dog clutch 90 includes a tubular clutch sleeve 91 provided radially outward of the end portion of the second transmission unit 80 on the first transmission unit 70 side and movable in the axial direction relative to the second transmission unit 80. The clutch sleeve 91 includes an internal spline 93 capable of meshing with the first external spline 74 when the internal spline 93 moves relative to the second external spline 83 toward the first external spline 74 in the axial direction while meshing with the second external spline 83.

More specifically, the first transmission unit 70 includes a first transmission unit main body 71, a first transmission unit flange portion 72, a first annular plate portion 73, the first external spline 74, and the like. The first transmission unit main body 71 is formed of, for example, metal in a substantially cylindrical shape. The first transmission unit flange portion 72 is integrally provided with the first transmission unit main body 71 of the same material as that of the first transmission unit main body 71 and is formed in an annular plate shape so as to extend radially outward from an outer peripheral wall of one end portion of the first transmission unit main body 71. The first annular plate portion 73 is integrally provided with the first transmission unit flange portion 72 of the same material as that of the first transmission unit flange portion 72 and is formed in an annular plate shape so as to extend radially outward from an outer peripheral wall of one end portion of the first transmission unit flange portion 72 in the axial direction.

The first external spline 74 is integrally provided with the first transmission unit flange portion 72 of the same material as that of the first transmission unit flange portion 72 so as to protrude radially outward from an outer peripheral wall of the other end portion of the first transmission unit flange portion 72 in the axial direction and linearly extend to the first annular plate portion 73. Multiple first external splines 74 are provided at equal intervals in a circumferential direction of the first transmission unit flange portion 72.

The bearing 64 is provided so that an outer peripheral wall thereof fits into the axial opening 612 and an inner peripheral wall of the clutch case extension tubular portion 614 of the clutch case 61. Two bearings 64 are provided side by side in the axial direction. The number of bearings 64 is not limited to two, and only one bearing 64 may be provided.

The first transmission unit 70 is provided such that an end portion of the first transmission unit main body 71 on the side opposite to the first transmission unit flange portion 72 is located outside the clutch case 61, and a center of the first transmission unit main body 71 in the axial direction is supported by the bearing 64 and the clutch case 61.

A first spline portion 711 is provided on an outer peripheral wall of the first transmission unit main body 71 on the side opposite to the first transmission unit flange portion 72. The first spline portion 711 can be spline-coupled to the end portion of the differential shaft 11 on the side opposite to the differential 9.

The second transmission unit 80 includes a second transmission unit main body 81, a second annular plate portion 82, and the second external spline 83. The second transmission unit main body 81 is formed of, for example, metal in a substantially cylindrical shape. The second annular plate portion 82 is integrally provided with the second transmission unit main body 81 of the same material as that of the second transmission unit main body 81 and is formed in an annular plate shape so as to extend radially outward from an outer peripheral wall at a center of the second transmission unit main body 81 in the axial direction.

The second external spline 83 is integrally provided with the second transmission unit main body 81 of the same material as that of the second transmission unit main body 81 so as to protrude radially outward from an outer peripheral wall of one end portion of the second transmission unit main body 81 in the axial direction and linearly extend to a vicinity of the second annular plate portion 82. Multiple second external splines 83 are provided at equal intervals in a circumferential direction of the second transmission unit main body 81.

The second transmission unit 80 is provided coaxially with the first transmission unit 70 such that an end surface of the second transmission unit main body 81 on a second external spline 83 side faces an end surface of the first transmission unit flange portion 72 on the side opposite to the first spline portion 711. The second transmission unit 80 is supported by the bearing 62 and the clutch case 61 on the side opposite to the second external spline 83 with respect to the second annular plate portion 82 in the axial direction. The second annular plate portion 82 is capable of coming into contact with an inner edge portion of one of the two bearings 62. Accordingly, the second transmission unit 80 is restricted from falling off the clutch case 61.

The bearing 65 is provided such that an inner peripheral wall thereof is fitted to the outer peripheral wall of the end portion of the first transmission unit main body 71 on the side opposite to the first spline portion 711, and an outer peripheral wall thereof is fitted to an inner peripheral wall of an end portion of the second transmission unit main body 81 on the second external spline 83 side. Accordingly, the end portion of the first transmission unit main body 71 on the side opposite to the first spline portion 711 is supported by the bearing 65, the second transmission unit main body 81, the bearing 62, and the clutch case 61.

An outer diameter of the first transmission unit flange portion 72 of the first transmission unit 70 is substantially the same as an outer diameter of an end portion of the second transmission unit main body 81 of the second transmission unit 80 on the first transmission unit 70 side. The number of the first external splines 74 in the circumferential direction of the first transmission unit flange portion 72 is the same as the number of the second external splines 83 in the circumferential direction of the second transmission unit main body 81.

A second spline portion 811 is provided on an inner peripheral wall at the center of the second transmission unit main body 81 in the axial direction. The second spline portion 811 can be spline-coupled to an end portion of the wheel shaft 12 on the side opposite to the wheel 13.

The sealing member 66 is formed of, for example, metal in a substantially circular plate shape. The sealing member 66 is provided on the first transmission unit 70 side with respect to the second spline portion 811 of the second transmission unit main body 81 such that an outer peripheral wall thereof is fitted to an inner peripheral wall of the second transmission unit main body 81. The sealing member 66 is capable of preventing liquid such as lubricating oil from flowing out from the differential shaft 11 to the wheel 13 via an inside of the first transmission unit main body 71 and an inside of the second transmission unit main body 81.

The oil seal 67 is formed of, for example, an elastic material such as rubber and a metal ring in an annular shape. An outer peripheral wall of the oil seal 67 is fitted to an inner peripheral wall of the axial opening 611 of the clutch case 61, and an inner edge portion of the oil seal 67 is capable of sliding contact with an outer peripheral wall of an end portion of the second transmission unit main body 81 on the side opposite to the second external spline 83. Accordingly, a space between the axial opening 611 of the clutch case 61 and the second transmission unit main body 81 is sealed to be airtight or liquid-tight.

The dog clutch 90 includes the clutch sleeve 91. The clutch sleeve 91 includes a sleeve main body 92, the internal spline 93, and a fork engagement recess 94. The sleeve main body 92 is formed of, for example, metal in a substantially cylindrical shape. The internal spline 93 is integrally provided with the sleeve main body 92 of the same material as that of the sleeve main body 92 so as to protrude radially inward from an inner peripheral wall of one end portion of the sleeve main body 92 in the axial direction and extend linearly to the other end portion. Multiple internal splines 93 are provided at equal intervals in a circumferential direction of the sleeve main body 92. The number of the internal splines 93 in the circumferential direction of the sleeve main body 92, the number of the first external splines 74 in the circumferential direction of the first transmission unit flange portion 72, and the number of the second external splines 83 in the circumferential direction of the second transmission unit main body 81 are the same.

The fork engagement recess 94 is formed in an annular shape so as to be recessed radially inward from an outer peripheral wall of one end portion of the sleeve main body 92 in the axial direction. An annular surface 941 having an annular and planar shape is provided on one side of the fork engagement recess 94 in the axial direction of the sleeve main body 92. An annular surface 942 having an annular and planar shape is provided on the other side of the fork engagement recess 94 in the axial direction of the sleeve main body 92.

The dog clutch 90 is provided such that the clutch sleeve 91 is located coaxially with the second transmission unit main body 81 and radially outward of the end portion of the second transmission unit main body 81 on the first transmission unit 70 side. The dog clutch 90 is spline-coupled to the second transmission unit 80 by the internal spline 93 meshing with the second external spline 83. Accordingly, the dog clutch 90 is movable in the axial direction relative to the second transmission unit 80 and is non-rotatable in the circumferential direction relative to the second transmission unit 80.

When the clutch sleeve 91 of the dog clutch 90 moves relative to the second transmission unit main body 81 toward the first transmission unit 70 in the axial direction, the internal spline 93 meshes with the first external spline 74. When the internal spline 93 meshes with the first external spline 74, relative rotation between the first transmission unit 70 and the second transmission unit 80 is restricted by the dog clutch 90, and transmission of torque between the first transmission unit 70 and the second transmission unit 80 is allowed.

On the other hand, when the clutch sleeve 91 moves relative to the first transmission unit 70 toward the second transmission unit 80 in the axial direction, meshing between the internal spline 93 and the first external spline 74 is released. When the meshing between the internal spline 93 and the first external spline 74 is released, the relative rotation between the first transmission unit 70 and the second transmission unit 80 is allowed, and the transmission of torque between the first transmission unit 70 and the second transmission unit 80 is interrupted.

A length of the clutch sleeve 91 in the axial direction is shorter than a length of the second transmission unit main body 81 from the end portion on the first transmission unit 70 side to the second annular plate portion 82, and longer than a length from the end portion of the first transmission unit flange portion 72 on the second transmission unit 80 side to the first annular plate portion 73. The clutch sleeve 91 is movable in the axial direction relative to the second transmission unit 80 and the first transmission unit 70 between the first annular plate portion 73 and the second annular plate portion 82. When the clutch sleeve 91 is in contact with the first annular plate portion 73, the internal spline 93 meshes with the first external spline 74 and the second external spline 83. When the clutch sleeve 91 is in contact with the second annular plate portion 82, the internal spline 93 meshes with the second external spline 83 but does not mesh with the first external spline 74.

“9” The electric actuator unit 20 and the clutch unit 60 are integrally provided such that the radial opening 212 and the radial opening 613 of the clutch case 61 communicate with each other. The actuator case 21 and the clutch case 61 are fastened by, for example, bolts (not shown).

In this way, by assembling the electric actuator unit 20 and the clutch unit 60 and attaching the electric actuator unit 20 and the clutch unit 60 to each other, it is possible to easily replace the electric actuator unit 20 and the clutch unit 60 when a failure occurs.

When the electric actuator unit 20 and the clutch unit 60 are integrally provided, the fork engagement portion 55 of the fork 50 enters the fork engagement recess 94 of the dog clutch 90. Therefore, when the rotary electric motor 30 rotates in a normal direction and the nut 42 moves toward the side opposite to the bearing portion 22 with respect to the shaft 41, the fork 50 also moves toward the side opposite to the bearing portion 22 with respect to the shaft 41. Accordingly, the fork engagement portion 55 comes into contact with the annular surface 942 of the fork engagement recess 94 to press the dog clutch 90 toward the first transmission unit 70. Accordingly, the dog clutch 90 moves toward the first transmission unit 70, and the internal spline 93 meshes with the first external spline 74.

On the other hand, when the rotary electric motor 30 rotates in a reverse direction and the nut 42 moves toward the bearing portion 22 relative to the shaft 41, the fork 50 also moves toward the bearing portion 22 relative to the shaft 41. Accordingly, the fork engagement portion 55 comes into contact with the annular surface 941 of the fork engagement recess 94 to press the dog clutch 90 toward the side opposite to the first transmission unit 70. Accordingly, the dog clutch 90 moves toward the side opposite to the first transmission unit 70, and meshing between the internal spline 93 and the first external spline 74 is released.

“8” As shown in FIG. 1, for example, the clutch device 10 is provided between the axle case 16 and the wheel 13 so as to be in contact with an outer wall of the axle case 16. The clutch device 10 is provided on the axle case 16 such that an outer peripheral wall of the clutch case extension tubular portion 614 fits into an inner peripheral wall of the axle case extension tubular portion 161. Accordingly, the clutch device 10 can be easily positioned with respect to the axle case 16.

For example, the clutch device 10 may be provided such that the outer peripheral wall of the clutch case extension tubular portion 614 fits into the inner peripheral wall of the axle case opening 160 without providing the axle case extension tubular portion 161 on the axle case 16. In this case as well, the clutch device 10 can be easily positioned with respect to the axle case 16.

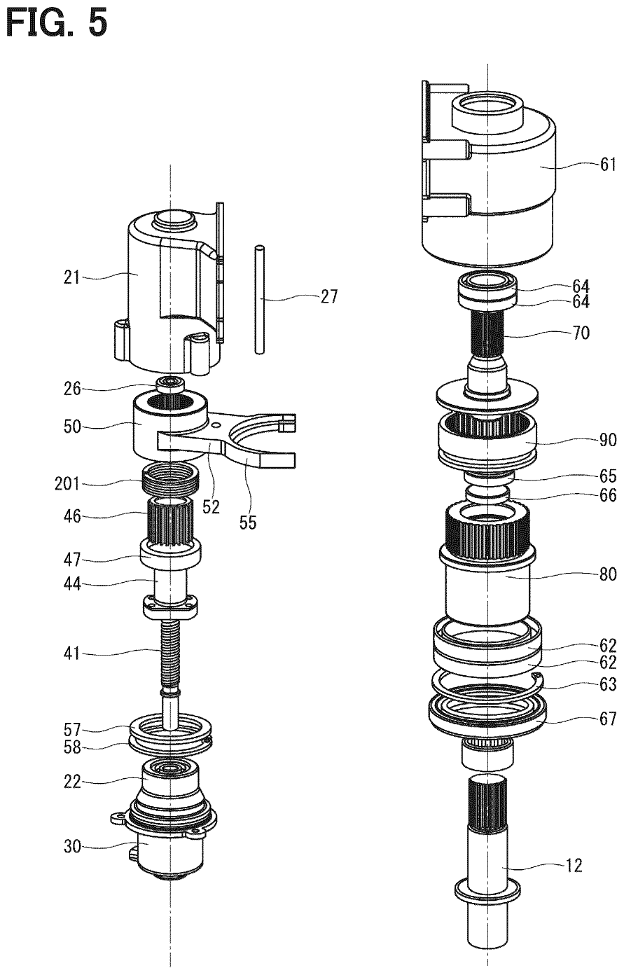

FIG. 5 is an exploded perspective view of the clutch device 10 to clarify shapes and dispositions of members constituting the clutch device 10.

<3> A chamfered portion 741, a chamfered portion 742, a chamfered portion 931, and a chamfered portion 932 are provided at end portions of the first external spline 74 on the second external spline 83 side and at end portions of the internal spline 93 on the first external spline 74 side.

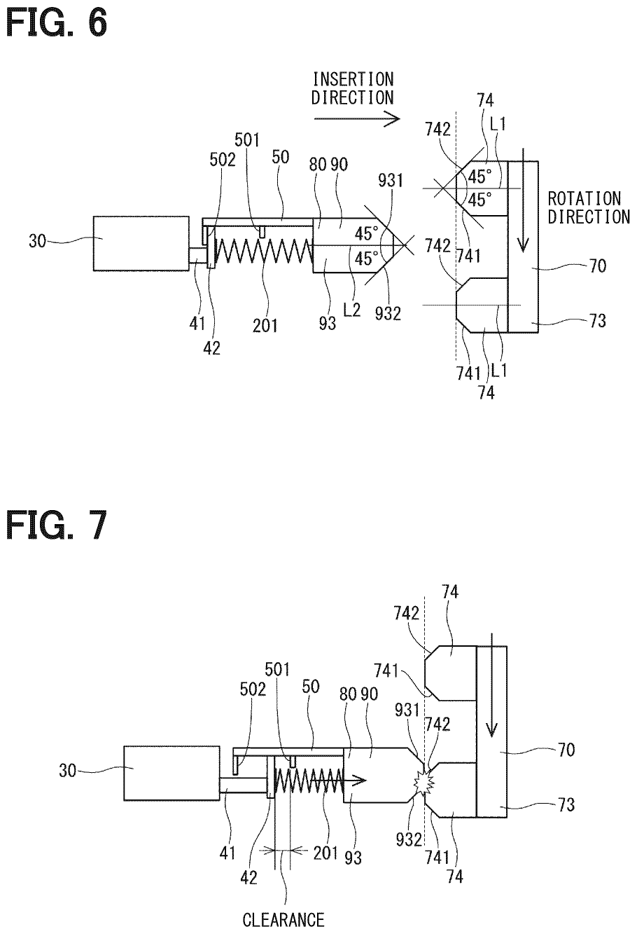

More specifically, as shown in FIG. 6, at the end portion of the first external spline 74 on the second external spline 83 side, the chamfered portion 741 is provided on one side in a circumferential direction of the first transmission unit 70, and the chamfered portion 742 is provided on the other side in the circumferential direction of the first transmission unit 70. Each of the chamfered portion 741 and the chamfered portion 742 is formed in a planar shape inclined at about 45 degrees with respect to a straight line L1 along a direction in which the first external spline 74 extends. Therefore, the first external spline 74 is formed in a shape that is line symmetrical with respect to the straight line L1 when viewed from a radially outer side of the first transmission unit 70.

At the end portion of the internal spline 93 on the first external spline 74 side, the chamfered portion 931 is provided on one side in a circumferential direction of the second transmission unit 80, and the chamfered portion 932 is provided on the other side in the circumferential direction of the second transmission unit 80. Each of the chamfered portion 931 and the chamfered portion 932 is formed in a planar shape inclined at about 45 degrees with respect to a straight line L2 along a direction in which the internal spline 93 extends. Therefore, the internal spline 93 is formed in a shape that is line symmetrical with respect to the straight line L2 when viewed from a radially outer side of the second transmission unit 80.

Next, an operation of the clutch device 10 will be described with reference to FIGS. 6 to 9.

In FIGS. 6 to 9, the shapes and dispositions of the members constituting the clutch device 10 are schematically shown, and are different from actual shapes and dispositions of the members.

As shown in FIG. 6, when the rotary electric motor 30 is not energized, the nut 42 is in contact with the movement restriction portion 502, and the internal spline 93 is separated from the first external spline 74. Therefore, the internal spline 93 does not mesh with the first external spline 74, and transmission of torque between the first transmission unit 70 and the second transmission unit 80 is interrupted.

As shown in FIG. 7, when the rotary electric motor 30 is energized, the shaft 41 rotates, and the nut 42 translates and moves to one side in the axial direction relative to the shaft 41. Accordingly, the nut 42 is separated from the movement restriction portion 502 and compresses the spring 201. Accordingly, the spring 201 biases the fork 50 and the dog clutch 90, and the internal spline 93 moves toward the first external spline 74. As a result, the end portion of the internal spline 93 on the first external spline 74 side comes into contact with an end portion of the first external spline 74 on an internal spline 93 side.

“10” While a clearance is provided between the nut 42 and the movement restriction portion 501, the biasing force of the spring 201 acts on the internal spline 93. Therefore, an impact force when the end portion of the internal spline 93 collides with the end portion of the first external spline 74 can be prevented from being transmitted to the nut 42, shaft 41, and rotary electric motor 30, thereby protecting these components.

While the clearance is provided between the nut 42 and the movement restriction portion 501, when differential rotation, which is a difference in rotational speed between the first transmission unit 70 and the second transmission unit 80, is equal to or greater than a predetermined value, the internal spline 93 can be prevented from meshing with the first external spline 74 by ratcheting the internal spline 93 and the first external spline 74. Accordingly, when the differential rotation between the first transmission unit 70 and the second transmission unit 80 is equal to or greater than the predetermined value, it is possible to prevent an impact caused by the internal spline 93 and the first external spline 74 meshing with each other. Therefore, it is possible to prevent transmission of an impact to a driver or the like of the vehicle 1 when the clutch device 10 is operated.

While the clearance is provided between the nut 42 and the movement restriction portion 501, when the differential rotation between the first transmission unit 70 and the second transmission unit 80 is reduced to the predetermined value or less, the fork 50 and the dog clutch 90 can be translated due to the biasing force of the spring 201 to mesh the internal spline 93 with the first external spline 74.

In this way, in the present embodiment, at a contact start position between the end portion of the internal spline 93 and the end portion of the first external spline 74, the nut 42 and the fork 50 are set to be in an intermediate floating position, which is a position between the movement restriction portion 501 and the movement restriction portion 502, such that ratcheting is possible by the spring 201 serving as a “waiting spring”, and the internal spline 93 and the first external spline 74 are capable of meshing with each other under a load of the spring 201. Accordingly, it is possible to achieve both the ratcheting between the internal spline 93 and the first external spline 74 and the meshing by the spring 201.

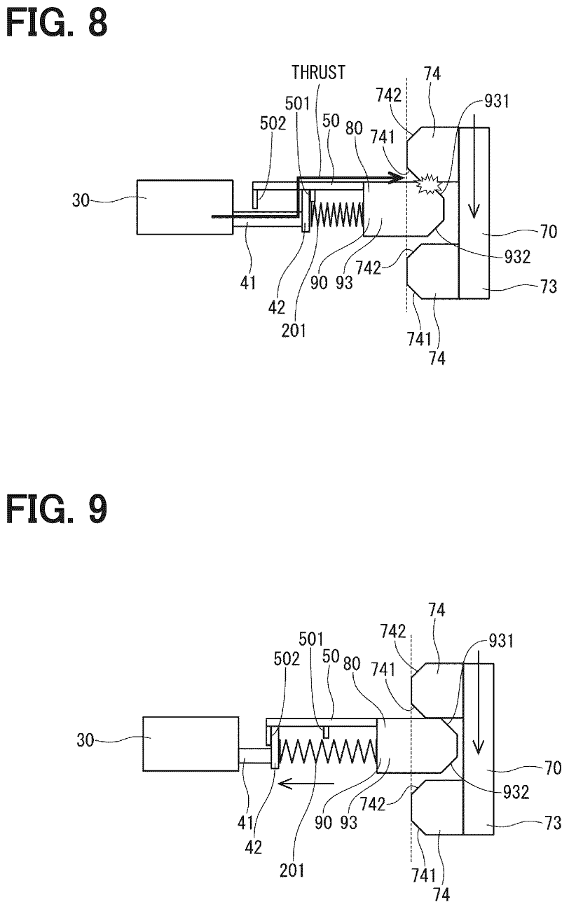

As shown in FIG. 8, when the nut 42 and the fork 50 move further in translation with rotation of the rotary electric motor 30 and the shaft 41, the nut 42 comes into contact with the movement restriction portion 501 while compressing the spring 201. Therefore, torque from the rotary electric motor 30 can be transmitted to the dog clutch 90 via the nut 42, the movement restriction portion 501, and the fork 50 without passing through the spring 201. Accordingly, when the internal spline 93 and the first external spline 74 start to mesh with each other, even when the differential rotation between the first transmission unit 70 and the second transmission unit 80 is equal to or greater than the predetermined value and a large frictional force is generated between a side surface of the internal spline 93 and a side surface of the first external spline 74, thrust equal to or greater than the frictional force can be applied from the rotary electric motor 30 to the dog clutch 90, and the internal spline 93 can reliably and quickly mesh with the first external spline 74.

“1” As shown in FIG. 9, when energization of the rotary electric motor 30 is stopped while the internal spline 93 and the first external spline 74 are meshed with each other, the nut 42 moves relative to the fork 50 toward the rotary electric motor 30 due to the biasing force of the spring 201, and comes into contact with the movement restriction portion 502. In this state, when the rotary electric motor 30 is energized and the shaft 41 is rotated in the reverse direction, the nut 42 translates toward the rotary electric motor 30 while being in contact with the movement restriction portion 502. Accordingly, the fork 50 and the dog clutch 90 also move in a direction away from the first transmission unit 70, and the meshing between the internal spline 93 and the first external spline 74 is released.

In this way, in the present embodiment, when the internal spline 93 and the first external spline 74 are meshed with each other, that is, when engagement of the dog clutch 90 is maintained, electric power supplied to the rotary electric motor 30 is reduced, and the nut 42 is brought into contact with the movement restriction portion 502 due to the biasing force of the spring 201, so that responsiveness of release of the meshing of the dog clutch 90 can be improved. By reducing electric power supplied to the rotary electric motor 30 when the engagement of the dog clutch 90 is maintained, power consumption of the clutch device 10 can be reduced.

“2” In the present embodiment, the ECU 100 is capable of quickly moving the internal spline 93 of the dog clutch 90 to a position where the internal spline 93 starts to come into contact with the first external spline 74 by controlling an operation of the rotary electric motor 30 (see FIGS. 6 and 7). The load of the spring 201 is set such that the internal spline 93 and the first external spline 74 is capable of meshing with each other under the load of the spring 201 after the internal spline 93 and the first external spline 74 start to come into contact with each other (see FIG. 7). Further, after the internal spline 93 and the first external spline 74 start to mesh with each other, the nut 42 is brought into contact with the movement restriction portion 501, so that thrust equal to or greater than a frictional force is applied from the rotary electric motor 30 to the dog clutch 90, and the internal spline 93 can be further moved relative to the first external spline 74 (see FIG. 8). Accordingly, it is possible to reliably and quickly complete the meshing between the internal spline 93 and the first external spline 74.

Next, the present embodiment will be compared with a comparative embodiment, and advantageous points of the present embodiment with respect to the comparative embodiment will be clarified.

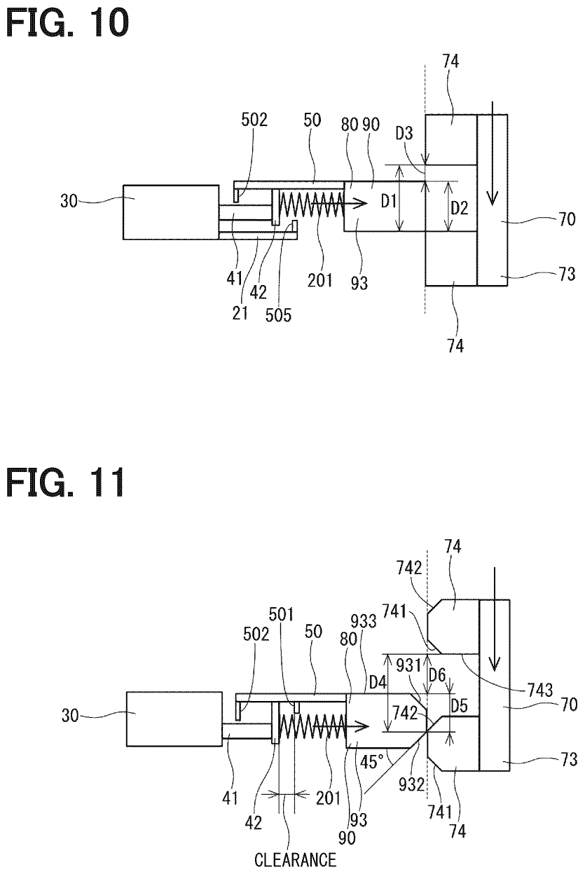

As shown in FIG. 10, the comparative embodiment is different from the present embodiment in that the internal spline 93 is not provided with the chamfered portion 931 and the chamfered portion 932 and the first external spline 74 is not provided with the chamfered portion 741 and the chamfered portion 742. The comparative embodiment is also different from the present embodiment in that the fork 50 is not provided with the movement restriction portion 501. When the nut 42 comes into contact with the movement restriction portion 505 provided on the actuator case 21, the nut 42 is restricted from being translated to the side opposite to the rotary electric motor 30.

As shown in FIG. 10, in the comparative embodiment, the internal spline 93 is not provided with the chamfered portion 931 and the chamfered portion 932 and the first external spline 74 is not provided with the chamfered portion 741 and the chamfered portion 742, so that a distance D1 between end portions of the first external splines 74 adjacent to each other in the circumferential direction of the first transmission unit 70 on the internal spline 93 side is relatively small, and a size D2 of end portions of the internal spline 93 on the first external spline 74 side in the circumferential direction of the second transmission unit 80 is relatively large. Therefore, an insertion margin D3, which is a difference between D1 and D2, becomes small. Accordingly, when the differential rotation between the first transmission unit 70 and the second transmission unit 80 is equal to or greater than the predetermined value, it may be difficult to insert the internal spline 93 between the first external splines 74, that is, to mesh the internal spline 93 with the first external spline 74.

In the comparative embodiment, although the biasing force of the spring 201 acts on the internal spline 93, since the internal spline 93 is not provided with the chamfered portion 931 and the chamfered portion 932 and the first external spline 74 is not provided with the chamfered portion 741 and the chamfered portion 742, it may become difficult to ratchet the internal spline 93 and the first external spline 74 together. When the differential rotation between the first transmission unit 70 and the second transmission unit 80 is equal to or greater than the predetermined value, when the internal spline 93 and the first external spline 74 mesh with each other, a large shock may occur at the time of meshing.

“5” On the other hand, as shown in FIG. 11, in the present embodiment, the internal spline 93 is provided with the chamfered portion 931 and the chamfered portion 932 and the first external spline 74 is provided with the chamfered portion 741 and the chamfered portion 742. Therefore, of the two first external splines 74 adjacent to each other in the circumferential direction of the first transmission unit 70, an insertion margin D6, which is a difference between a distance D4 from a side surface 743 of one first external spline 74 on a chamfered portion 741 side to an end portion of the chamfered portion 742 of the other first external spline 74 on the chamfered portion 741 side and a distance D5 from a side surface 933 of one internal spline 93 on a chamfered portion 931 side to the chamfered portion 932, is larger than the insertion margin D3 in the comparative embodiment. Accordingly, even when the differential rotation between the first transmission unit 70 and the second transmission unit 80 is equal to or greater than the predetermined value, it is easy to insert the internal spline 93 between the first external splines 74, that is, to mesh the internal spline 93 with the first external spline 74.

In the present embodiment, the internal spline 93 is provided with the chamfered portion 931 and the chamfered portion 932 and the first external spline 74 is provided with the chamfered portion 741 and the chamfered portion 742, and while a clearance is provided between the nut 42 and the movement restriction portion 501, the biasing force of the spring 201 acts on the internal spline 93. Therefore, when the differential rotation between the first transmission unit 70 and the second transmission unit 80 is equal to or greater than the predetermined value, the internal spline 93 and the first external spline 74 can be ratcheted together to prevent the internal spline 93 from meshing with the first external spline 74. Accordingly, abnormal meshing, which is a phenomenon in which the internal spline 93 meshes with the first external spline 74 when the differential rotation between the first transmission unit 70 and the second transmission unit 80 is equal to or greater than the predetermined value, can be prevented.

In the present embodiment, when a rotational speed of the first transmission unit 70 is higher than a rotational speed of the second transmission unit 80, when the internal spline 93 moves toward the first external spline 74, the chamfered portion 931 of the internal spline 93 and the chamfered portion 741 of the first external spline 74 come into contact with each other. At this time, when the differential rotation between the first transmission unit 70 and the second transmission unit 80 is equal to or greater than the predetermined value, the internal spline 93 moves in a direction away from the first external spline 74 while the chamfered portion 931 slides against the chamfered portion 741, thereby enabling the internal spline 93 and the first external spline 74 to ratchet together.

On the other hand, when the rotational speed of the first transmission unit 70 is lower than the rotational speed of the second transmission unit 80, when the internal spline 93 moves toward the first external spline 74, the chamfered portion 932 of the internal spline 93 and the chamfered portion 742 of the first external spline 74 come into contact with each other. At this time, when the differential rotation between the first transmission unit 70 and the second transmission unit 80 is equal to or greater than the predetermined value, the internal spline 93 moves in the direction away from the first external spline 74 while the chamfered portion 932 slides against the chamfered portion 742, thereby enabling the internal spline 93 and the first external spline 74 to ratchet together.

In the present embodiment, each of the chamfered portion 741 and the chamfered portion 742 is formed in a planar shape inclined at about 45 degrees with respect to the straight line L1 along the direction in which the first external spline 74 extends. Each of the chamfered portion 931 and the chamfered portion 932 is formed in a planar shape inclined at about 45 degrees with respect to the straight line L2 along the direction in which the internal spline 93 extends (see FIG. 6). Therefore, regardless of whether the rotational speed of the first transmission unit 70 is higher or lower than the rotational speed of the second transmission unit 80, it is possible to easily cause the internal spline 93 and the first external spline 74 to ratchet together.

In the present embodiment, the first external spline 74 is formed in a shape that is line symmetrical with respect to the straight line L1 when viewed from the radially outer side of the first transmission unit 70. The internal spline 93 is formed in a shape that is line symmetrical with respect to the straight line L2 when viewed from the radially outer side of the second transmission unit 80 (see FIG. 6). Therefore, the first external spline 74 and the internal spline 93 can be easily machined, and the clutch device 10 can be easily manufactured.

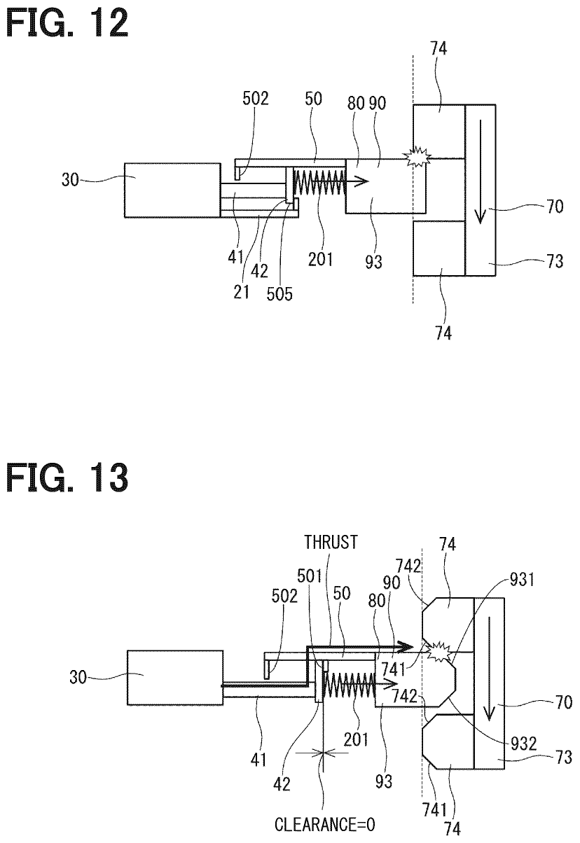

As shown in FIG. 12, in the comparative embodiment, in a state where the internal spline 93 and the first external spline 74 start to mesh with each other, when the differential rotation between the first transmission unit 70 and the second transmission unit 80 is equal to or greater than the predetermined value, a large frictional force is generated between the side surface of the internal spline 93 and the side surface of the first external spline 74. Only the biasing force of the spring 201 acts on the internal spline 93. Therefore, when the frictional force between the internal spline 93 and the first external spline 74 is larger than the biasing force of the spring 201, the internal spline 93 cannot be further moved relative to the first external spline 74. Accordingly, it may be difficult to reliably mesh the internal spline 93 with the first external spline 74.

On the other hand, as shown in FIG. 13, in the present embodiment, by bringing the nut 42 into contact with the movement restriction portion 501, the thrust of the rotary electric motor 30 can be applied to the dog clutch 90 via the fork 50. Therefore, when the internal spline 93 and the first external spline 74 start to mesh with each other, even when the differential rotation between the first transmission unit 70 and the second transmission unit 80 is equal to or greater than the predetermined value and a large frictional force is generated between the side surface of the internal spline 93 and the side surface of the first external spline 74, thrust equal to or greater than the frictional force can be applied from the rotary electric motor 30 to the dog clutch 90, and the internal spline 93 can be further moved relative to the first external spline 74. Accordingly, the internal spline 93 can be meshed with the first external spline 74 reliably and quickly.

Next, an operation example of the clutch device 10 according to the present embodiment will be described.

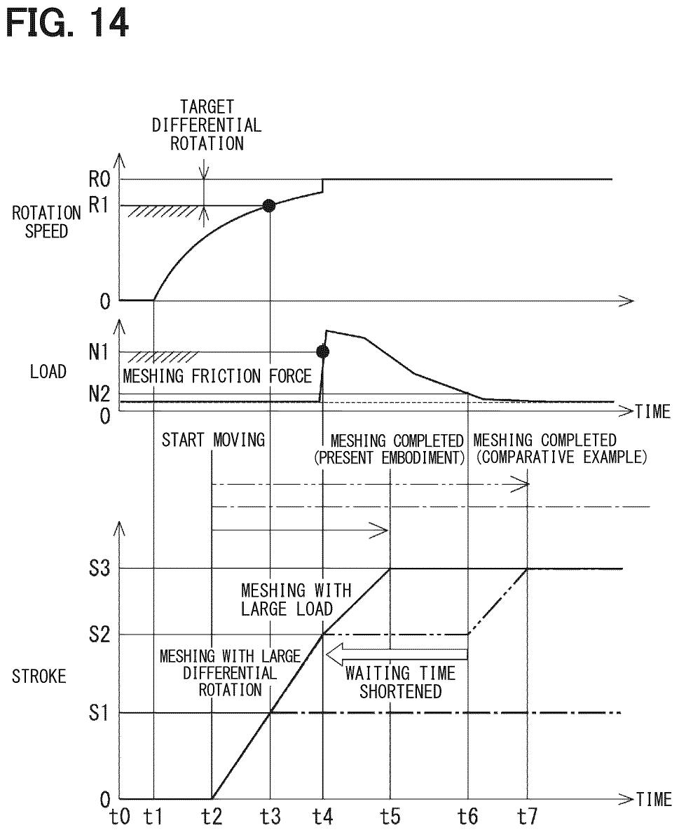

At a time to in FIG. 14, a rotation speed of the wheel 13 and the second transmission unit 80 is R0.

As shown in FIG. 14, when rotation of the motor generator 2 is started at a time t1, a rotation speed of the first transmission unit 70 increases thereafter. Accordingly, after the time t1, the differential rotation between the first transmission unit 70 and the second transmission unit 80 decreases.

When rotation of the rotary electric motor 30 of the clutch device 10 is started at a time t2, an amount of stroke, which is movement of the dog clutch 90 in the axial direction, increases thereafter. A stroke amount of the dog clutch 90 in a state in contact with the second annular plate portion 82 (initial position) is set to 0. When the dog clutch 90 in contact with the second annular plate portion 82 moves toward the first annular plate portion 73, the stroke amount increases.

When the rotation speed of the first transmission unit 70 becomes R1 at a time t3 and the differential rotation between the first transmission unit 70 and the second transmission unit 80 becomes equal to or less than target differential rotation, the stroke amount becomes S1, and the end portion of the internal spline 93 on the first external spline 74 side comes into contact with the end portion of the first external spline 74 on the internal spline 93 side (see FIG. 7).

In the present embodiment, since the internal spline 93 is provided with the chamfered portion 931 and the chamfered portion 932, and the first external spline 74 is provided with the chamfered portion 741 and the chamfered portion 742, even when the differential rotation between the first transmission unit 70 and the second transmission unit 80 is equal to or greater than a predetermined value when the differential rotation is equal to or less than the target differential rotation, the internal spline 93 can be inserted between the first external splines 74 (see FIG. 11). Therefore, engagement, that is, meshing at high differential rotation is possible. Accordingly, the target differential rotation can be set large, and the target differential rotation can be increased.

After the time t3, the dog clutch 90 is moved toward the first annular plate portion 73 due to the biasing force of the spring 201. Therefore, the stroke amount increases in accordance with the movement of the dog clutch 90.

At a time t4, when the stroke amount becomes S2 and the internal spline 93 and the first external spline 74 start to mesh with each other, the nut 42 comes into contact with the movement restriction portion 501 (see FIG. 8). At this time (time t4), due to the differential rotation between the first transmission unit 70 and the second transmission unit 80, a frictional force N1 as a load is generated between the internal spline 93 and the first external spline 74.

In the present embodiment, after the time t4, thrust equal to or greater than the frictional force N1 is applied from the rotary electric motor 30 to the dog clutch 90, so that the stroke amount of the dog clutch 90 increases. In this way, in the present embodiment, engagement, that is, meshing, at a high load is possible.

After the time t4, the rotation speed of the first transmission unit 70 is equal to a rotation speed R0 of the second transmission unit 80.

At a time t5, the stroke amount becomes S3, the dog clutch 90 comes into contact with the first annular plate portion 73, and the meshing between the internal spline 93 and the first external spline 74 is completed.

An operation example according to the comparative embodiment is shown by dashed dotted line in FIG. 14. At the time t3, since the differential rotation between the first transmission unit 70 and the second transmission unit 80 is equal to or greater than the predetermined value, in the comparative embodiment, the internal spline 93 cannot be inserted between the first external splines 74, that is, the internal spline 93 cannot mesh with the first external spline 74 (see FIG. 10). Therefore, even after the time t3, a state in which the internal spline 93 cannot mesh with the first external spline 74 continues.

Another operation example according to the comparative embodiment is shown by a two-dot chain line in FIG. 14. At the time t4, in a state where the internal spline 93 and the first external spline 74 start to mesh with each other, the differential rotation between the first transmission unit 70 and the second transmission unit 80 is equal to or greater than the predetermined value, and the frictional force N1 is generated between the internal spline 93 and the first external spline 74. In the comparative embodiment, only the biasing force of the spring 201 acts on the internal spline 93. Therefore, when the frictional force N1 between the internal spline 93 and the first external spline 74 is larger than the biasing force of the spring 201, the internal spline 93 cannot be further moved relative to the first external spline 74 (see FIG. 12). Therefore, even after the time t4, a state in which the internal spline 93 cannot be further moved relative to the first external spline 74 continues.

At a time t6, when the frictional force between the internal spline 93 and the first external spline 74 becomes equal to or less than N2 (a value smaller than N1) and becomes smaller than the biasing force of the spring 201, the internal spline 93 can be further moved relative to the first external spline 74. Accordingly, after the time t6, the stroke amount increases, and at a time t7, the meshing between the internal spline 93 and the first external spline 74 is completed.

In this way, in the comparative embodiment, after the internal spline 93 and the first external spline 74 start to mesh with each other (time t4), it is necessary to wait until the frictional force between the internal spline 93 and the first external spline 74 becomes smaller than the biasing force of the spring 201 (time t6) to complete the meshing between the internal spline 93 and the first external spline 74.

On the other hand, in the present embodiment, after the meshing between the internal spline 93 and the first external spline 74 is started (time t4), an operation for completing the meshing between the internal spline 93 and the first external spline 74 can be started immediately, thereby shortening a waiting time (t6−t4).

As described above, <1> in the present embodiment, the fork 50 includes the fork base 51, the movement restriction portion 501, and the movement restriction portion 502. The tubular fork base 51 is provided radially outward of the nut 42, and is movable in the axial direction relative to the nut 42. The movement restriction portion 501 and the movement restriction portion 502 are capable of restricting relative movement of the fork base 51 in the axial direction with respect to the nut 42. The electric actuator unit 20 includes a spring 201 provided between the nut 42 and the fork base 51 and capable of biasing the fork base 51 in the axial direction relative to the nut 42.

In the present embodiment, while a frictional force is generated at the time of meshing between the dog clutch 90 and the first transmission unit 70, relative movement of the fork base 51 in the axial direction with respect to the nut 42 is restricted by the movement restriction portion 501, so that torque from the rotary electric motor 30 can be transmitted to the dog clutch 90 via the nut 42, the movement restriction portion 501, and the fork 50 without passing through the spring 201. Accordingly, thrust equal to or greater than the frictional force can be applied from the rotary electric motor 30 to the dog clutch 90, and a waiting time due to a meshing impact can be shortened. Since thrust equal to or greater than the frictional force can be applied from the rotary electric motor 30 to the dog clutch 90, the dog clutch 90 can be reliably and quickly meshed with the first transmission unit 70. Accordingly, responsiveness of the clutch device 10 can be enhanced.

In the present embodiment, when engagement of the dog clutch 90 is maintained, electric power supplied to the rotary electric motor 30 is reduced, and the nut 42 is brought into contact with the movement restriction portion 502 due to the biasing force of the spring 201, so that responsiveness of release of the meshing of the dog clutch 90 can be improved.

In the present embodiment, while the clearance is provided between the nut 42 and the movement restriction portion 501, the biasing force of the spring 201 acts on the dog clutch 90. Therefore, it is possible to prevent transmission of an impact force to the nut 42, the shaft 41, and the rotary electric motor 30 when an end portion of internal teeth of the dog clutch 90 collides with an end portion of external teeth of the first transmission unit 70, and to protect these members.

In a clutch device disclosed in the comparative example described above, a frictional force generated when internal teeth of a clutch sleeve and external teeth of a first transmission unit mesh with each other may cause a rotary electric motor to generate a high load, and a waiting spring may be completely crushed, which may cause a spring compression (strength) design to become invalid.

In contrast, in the present embodiment, the nut 42 is configured to be in contact with the movement restriction portion 501, so that a spring compression (strength) design is easily established without crushing the spring 201.

<2> In the present embodiment, the nut 42 includes the rotation restriction portion 400 capable of restricting the relative rotation of the nut 42 with respect to the fork base 51.

Therefore, it is possible to achieve a structure for preventing the nut 42 from rotating relative to the actuator case 21 without relying on the rotation prevention shaft 27 or the like, and it is possible to simplify a configuration of the clutch device 10.

<3> <1-3> In the present embodiment, the first transmission unit 70 includes the first external spline 74 at the end portion on the second transmission unit 80 side. The second transmission unit 80 includes the second external spline 83 at the end portion on the first transmission unit 70 side. The dog clutch 90 includes the tubular clutch sleeve 91 provided radially outward of the end portion of the second transmission unit 80 on the first transmission unit 70 side and movable in the axial direction relative to the second transmission unit 80. The clutch sleeve 91 includes the internal spline 93 capable of meshing with the first external spline 74 when the internal spline 93 moves relative to the second external spline 83 toward the first external spline 74 in the axial direction while meshing with the second external spline 83. In this way, in the present embodiment, a sleeve-type clutch is included in which the internal spline 93 of the sleeve-shaped clutch sleeve 91 and the first external spline 74 of the first transmission unit 70 mesh with each other.

The chamfered portion 741, the chamfered portion 742, the chamfered portion 931, and the chamfered portion 932 are provided at the end portions of the first external spline 74 on the second external spline 83 side and at the end portions of the internal spline 93 on the first external spline 74 side.

Even when the differential rotation between the first transmission unit 70 and the second transmission unit 80 is equal to or greater than the predetermined value, it is easy to insert the internal spline 93 between the first external splines 74, that is, to mesh the internal spline 93 with the first external spline 74.

When the differential rotation between the first transmission unit 70 and the second transmission unit 80 is equal to or greater than the predetermined value, the internal spline 93 and the first external spline 74 can be easily ratcheted together. Therefore, when the differential rotation between the first transmission unit 70 and the second transmission unit 80 is equal to or greater than the predetermined value, the internal spline 93 can be prevented from meshing with the first external spline 74, and abnormal meshing, which is a phenomenon in which the internal spline 93 meshes with the first external spline 74 and a large shock occurs when the differential rotation between the first transmission unit 70 and the second transmission unit 80 is equal to or greater than the predetermined value, can be prevented.

<4> In the present embodiment, the nut 42 includes the tubular inner nut portion 44 that moves in the axial direction relative to the shaft 41 when the shaft 41 rotates, and the tubular outer nut portion 45 provided radially outward of the inner nut portion 44 so as to be non-rotatable relative to the inner nut portion 44 and movable and slidable in the axial direction relative to the fork base 51.

In this way, the nut 42 is divided into the inner nut portion 44 that is a member having “a rotational translation conversion function” and the outer nut portion 45 that is a member having “a sliding function with respect to the fork 50”, so that the nut 42 can be easily manufactured, and manufacturing cost can be reduced.

In the present embodiment, the outer nut portion 45 includes the first outer nut portion 46, which is a member having “a rotation prevention function and a sliding function with respect to the fork 50”, and the second outer nut portion 47, which is a member having “a sliding function and a movement restriction function with respect to the fork 50”. Therefore, the nut 42 can be manufactured more easily, and the manufacturing cost can be reduced.

<5> In the present embodiment, the rotary electric motor 30, the shaft 41, the nut 42, the fork base 51, and the spring 201 are coaxially provided.

Therefore, a size of the clutch device 10 in the radial direction can be reduced.

In a fork drive mechanism described in U.S. Pat. No. 5,517,876B, a rotary electric motor and a rotational translation unit are disposed coaxially, and a sleeve, a spring, and a fork are disposed coaxially, each of which is provided on a different shaft. Therefore, a size of the fork drive mechanism in a radial direction may be increased. The sleeve, the spring, and the fork are disposed in series in an axial direction. Therefore, a size of the fork drive mechanism in the axial direction may increase.

In contrast, in the present embodiment, the rotary electric motor 30, the shaft 41 and the nut 42 of the rotational translation unit 40, the fork base 51, and the spring 201 are disposed coaxially, and the fork base 51 and the spring 201 are disposed radially outward of the rotational translation unit 40. Accordingly, sizes of the clutch device 10 in the radial direction and in the axial direction can be reduced.

<1-1> The present embodiment further includes the ECU 100 as the “control unit”. The ECU 100 is capable of controlling operations of the rotary electric motor 30 and the electric actuator unit 20 by controlling energization of the rotary electric motor 30.

In the present embodiment, the ECU 100 is capable of controlling an operation of the rotary electric motor 30 to move the dog clutch 90 to a position where the dog clutch 90 starts to come into contact with the first transmission unit 70. A load of the spring 201 is set such that, after the dog clutch 90 and the first transmission unit 70 start to come into contact with each other, the dog clutch 90 and the first transmission unit 70 are meshed with each other under the load of the spring 201. Therefore, electric power supplied to the rotary electric motor 30 can be reduced, and power consumption of the clutch device 10 can be reduced.

<1-2> In the present embodiment, after the dog clutch 90 and the first transmission unit 70 start to mesh with each other, the ECU 100 controls an operation of the rotary electric motor 30 to bring the nut 42 into contact with the movement restriction portion 501, apply thrust from the rotary electric motor 30 to the dog clutch 90 without passing through the spring 201, and move the dog clutch 90 relative to the first transmission unit 70. Therefore, it is possible to reliably and quickly complete the meshing between the dog clutch 90 and the first transmission unit 70.

### Second Embodiment

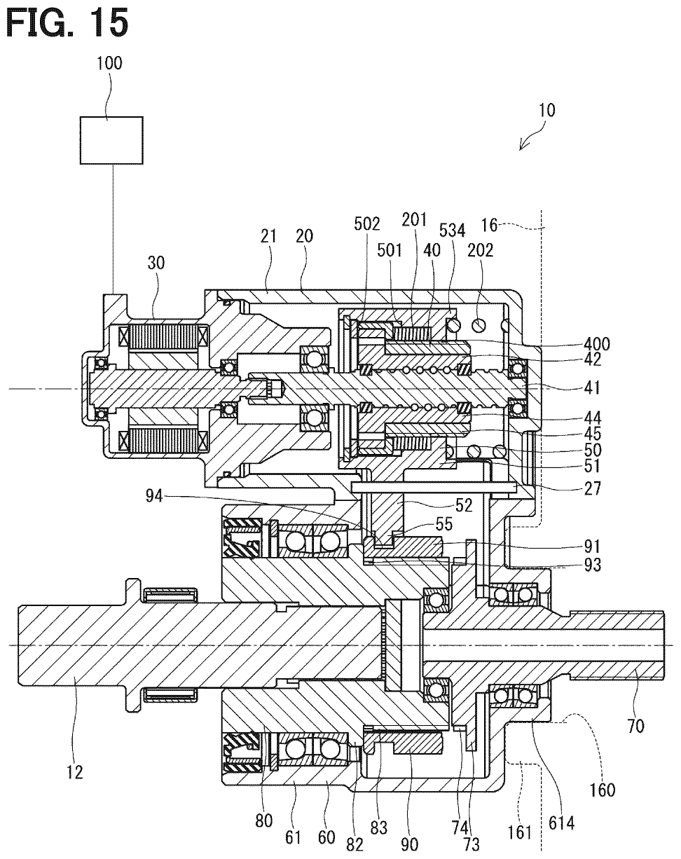

FIG. 15 shows the clutch device according to a second embodiment. The second embodiment is different from the first embodiment in a configuration of the electric actuator unit 20 and the like.

“3” In the present embodiment, the electric actuator unit 20 further includes a return spring 202. The return spring 202 is a coil spring formed by winding a wire made of metal, for example, into a coil shape.

In the present embodiment, the fork 50 includes a fork extension tubular portion 534. The fork extension tubular portion 534 is integrally provided with the fork base 51 of the same material as that of the fork base 51 so as to extend in a tubular shape from an outer edge portion of an end surface of the fork base 51 on the side opposite to the rotary electric motor 30.

The return spring 202 is provided radially outward of the shaft 41 such that one end portion of the return spring 202 in the axial direction is in contact with the end surface of the fork base 51 on the side opposite to the rotary electric motor 30 and the other end portion of the return spring 202 in the axial direction is in contact with the inner wall of the actuator case 21. One end portion of the return spring 202 in the axial direction is located radially inward of the fork extension tubular portion 534. Accordingly, it is possible to prevent the one end portion of the return spring 202 in the axial direction from being displaced from the end surface of the fork base 51.

The return spring 202 has a force extending in the axial direction. Therefore, when the rotary electric motor 30 is not energized, the fork 50 is biased toward the rotary electric motor 30 due to a biasing force of the return spring 202. Accordingly, the dog clutch 90 is pressed against the second annular plate portion 82.

The biasing force of the return spring 202 is set to be smaller than the biasing force of the spring 201.

In the present embodiment, when the rotary electric motor 30 is not energized, the dog clutch 90 is not meshed with the first transmission unit 70 due to the return spring 202. Therefore, when applied to the vehicle 1 in which an interruption period of transmission of torque between the first transmission unit 70 and the second transmission unit 80 is long, power consumption of the clutch device 10 can be reduced.

For example, when the rotary electric motor 30 fails during traveling of the vehicle 1, a fail-safe measure can be taken by stopping energization of the rotary electric motor 30, thereby releasing meshing between the dog clutch 90 and the first transmission unit 70 and interrupting transmission of torque between the first transmission unit 70 and the second transmission unit 80.

### Third Embodiment

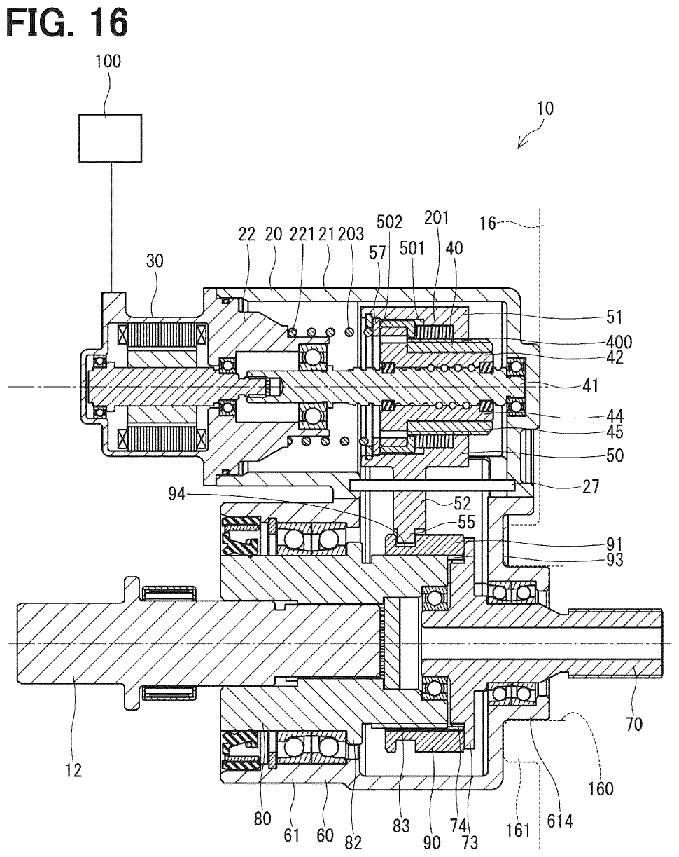

FIG. 16 shows the clutch device according to a third embodiment. The third embodiment is different from the first embodiment in a configuration of the electric actuator unit 20 and the like.

“3” In the present embodiment, the electric actuator unit 20 further includes a return spring 203. The return spring 203 is a coil spring formed by winding a wire made of metal, for example, into a coil shape.

In the present embodiment, the bearing portion 22 includes a bearing portion step surface 221. The bearing portion step surface 221 is formed in an annular and planar shape on an outer wall of the bearing portion 22 so as to face the washer 57 of the fork 50.

The return spring 203 is provided radially outward of the shaft 41 such that one end portion of the return spring 203 in the axial direction is in contact with the bearing portion step surface 221 and the other end portion of the return spring 203 in the axial direction is in contact with the washer 57.

The return spring 203 has a force extending in the axial direction. Therefore, when the rotary electric motor 30 is not energized, the fork 50 is biased toward the side opposite to the rotary electric motor 30 due to a biasing force of the return spring 203. Accordingly, the dog clutch 90 is pressed against the first annular plate portion 73.

The biasing force of the return spring 203 is set to be smaller than the biasing force of the spring 201.

In the present embodiment, when the rotary electric motor 30 is not energized, the dog clutch 90 can be meshed with the first transmission unit 70 due to the return spring 203. Therefore, when applied to the vehicle 1 in which a permissible period of transmission of torque between the first transmission unit 70 and the second transmission unit 80 is long, power consumption of the clutch device 10 can be reduced.

For example, when the rotary electric motor 30 fails during traveling of the vehicle 1, a fail-safe measure can be taken by stopping energization of the rotary electric motor 30, thereby meshing the dog clutch 90 and the first transmission unit 70 with each other and allowing transmission of torque between the first transmission unit 70 and the second transmission unit 80.

### Fourth Embodiment

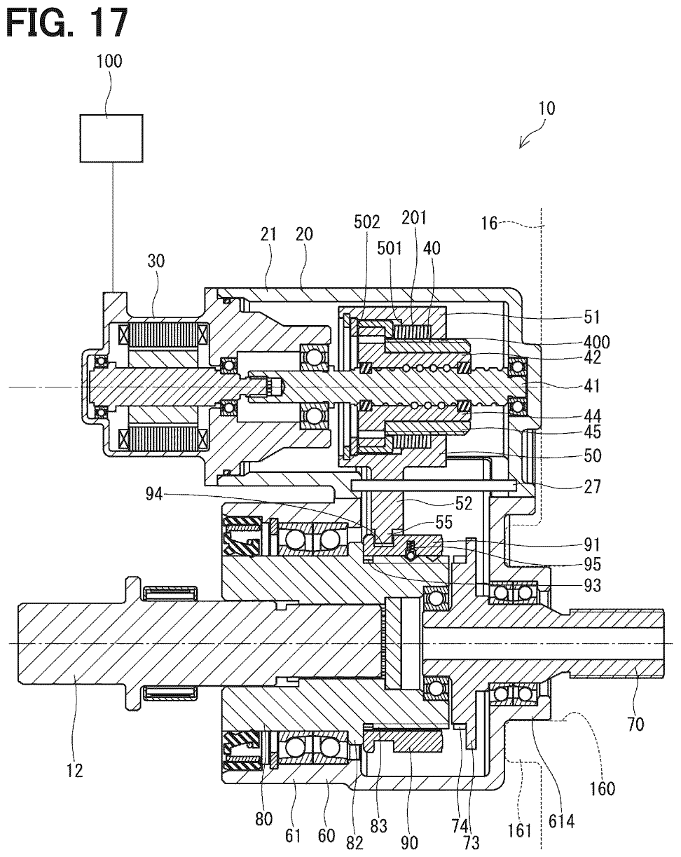

FIG. 17 shows the clutch device according to a fourth embodiment. The fourth embodiment is different from the first embodiment in a configuration of the clutch unit 60 and the like.

“7” In the present embodiment, the dog clutch 90 includes a detent mechanism 95.

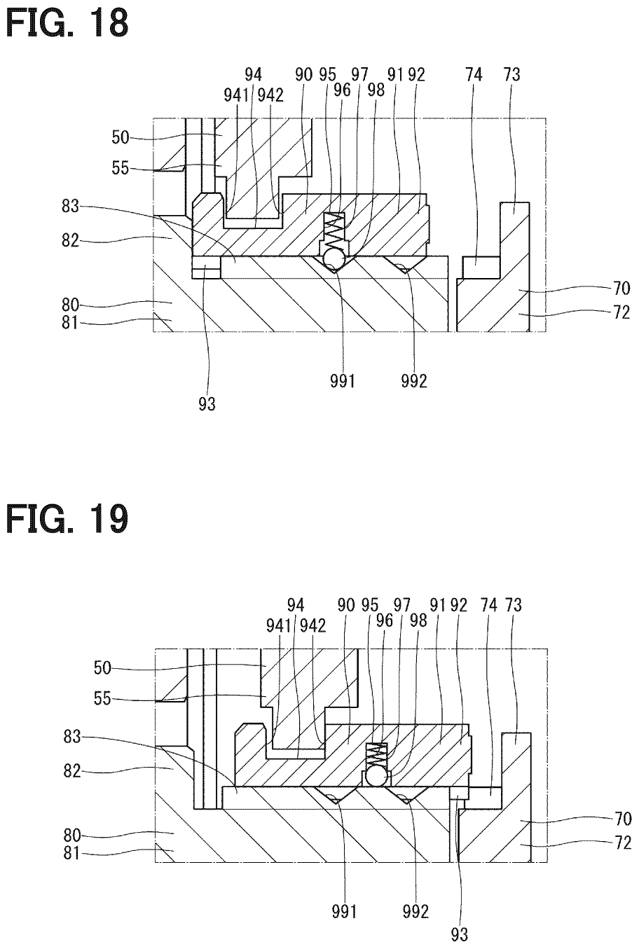

As shown in FIG. 18, the detent mechanism 95 includes a detent hole 96, a detent spring 97, a detent ball 98, a first detent recess 991, and a second detent recess 992. The detent hole 96 is recessed radially outward from an inner peripheral wall of the sleeve main body 92. The detent spring 97 is a coil spring formed by winding a wire made of metal, for example, into a coil shape. The detent spring 97 is accommodated in the detent hole 96 such that one end portion the detent spring 97 in the axial direction is in contact with a bottom surface of the detent hole 96.

The detent ball 98 is provided at an opening of the detent hole 96 so as to be in contact with the other end portion of the detent spring 97 in the axial direction. The first detent recess 991 and the second detent recess 992 are provided in, for example, the second external spline 83. The first detent recess 991 and the second detent recess 992 are recessed radially inwardly of the second transmission unit main body 81 from an outer wall of one of the second external splines 83.

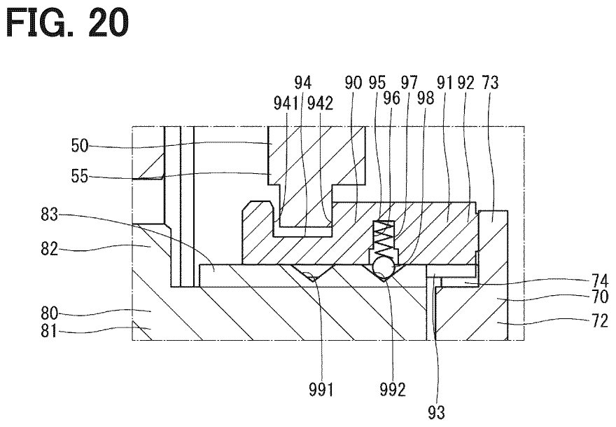

The first detent recess 991 is formed on an axis of the detent hole 96 when the sleeve main body 92 comes into contact with the second annular plate portion 82 (see FIG. 18). The second detent recess 992 is formed on the axis of the detent hole 96 when the sleeve main body 92 comes into contact with the first annular plate portion 73 (see FIG. 20).

The first detent recess 991 and the second detent recess 992 are provided so that the detent ball 98 is capable of entering therein. When the detent ball 98 enters the first detent recess 991 or the second detent recess 992, a portion of the detent ball 98 is located inside the opening of the detent hole 96 (see FIGS. 18 and 20).

On the other hand, when the detent ball 98 does not enter the first detent recess 991 or the second detent recess 992, the entire detent ball 98 is located inside the opening of the detent hole 96 (see FIG. 19).

With the configuration, in an initial state in which the dog clutch 90 comes into contact with the second annular plate portion 82, the detent ball 98 enters the first detent recess 991, and a relative position of the dog clutch 90 in the axial direction with respect to the second transmission unit 80 is maintained (see FIG. 18). Accordingly, even when the energization of the rotary electric motor 30 is stopped, a state in which transmission of torque between the first transmission unit 70 and the second transmission unit 80 is interrupted can be maintained.

When the rotary electric motor 30 is energized from the initial state shown in FIG. 18 and the fork 50 translates the dog clutch 90 toward the first transmission unit 70, the detent ball 98 comes out of the first detent recess 991 and is located between the first detent recess 991 and the second detent recess 992 (see FIG. 19). In this state, even when the energization of the rotary electric motor 30 is stopped, a relative position of the dog clutch 90 in the axial direction with respect to the second transmission unit 80 is not maintained.

When the fork 50 further translates the dog clutch 90 toward the first transmission unit 70 from the state shown in FIG. 19, the dog clutch 90 comes into contact with the first annular plate portion 73, the detent ball 98 enters the second detent recess 992, and a relative position of the dog clutch 90 in the axial direction with respect to the second transmission unit 80 is maintained (see FIG. 20). Accordingly, even when the energization of the rotary electric motor 30 is stopped, a state in which transmission of torque between the first transmission unit 70 and the second transmission unit 80 is allowed can be maintained.

In the present embodiment, by holding the relative position of the dog clutch 90 in the axial direction with respect to the second transmission unit 80 by the detent mechanism 95, energization of the rotary electric motor 30 can be stopped as appropriate. Accordingly, power consumption of the clutch device 10 can be reduced.

### Other Embodiments

In the above-described embodiment, the nut, the fork base, the inner nut portion, and the outer nut portion are formed in a tubular shape. In contrast, in another embodiment, the nut, the fork base, the inner nut portion, and the outer nut portion may be formed in, for example, an annular shape.

In the above-described embodiment, an example is described in which the chamfered portion provided at the end portion of the first external spline on the second external spline side and the chamfered portion provided at the end portion of the internal spline on the first external spline side are in a planar shape inclined at about 45 degrees with respect to the straight line along the directions in which the first external spline and the internal spline extend. In contrast, in another embodiment, the chamfered portion may be formed in a planar shape inclined at an angle other than 45 degrees with respect to the straight line or in a curved surface shape. In another embodiment, the end portion of the first external spline on the second external spline side and the end portion of the internal spline on the first external spline side may not have the chamfered portion.

In the above-described embodiment, an example is described in which the sleeve-type clutch is applied in which the internal spline 93 of the sleeve-shaped clutch sleeve 91 and the first external spline 74 of the first transmission unit 70 mesh with each other. In contrast, in another embodiment, for example, a face-type clutch may be applied in which a drive dog provided at a tip of the dog clutch 90 and a driven dog provided on the first transmission unit 70 face and mesh with each other in the axial direction. Even when the face-type clutch is applied, a similar effect as in a case where the sleeve-type clutch is applied can be achieved.

In the above-described embodiment, an example is described in which the nut is constituted by the inner nut portion and the outer nut portion which are separate bodies. In contrast, in another embodiment, the inner nut portion and the outer nut portion may be integrally provided to form a nut.

In the above-described embodiment, an example is described in which the differential shaft 11 is connected to the first transmission unit 70, and the wheel shaft 12 is connected to the second transmission unit 80. In contrast, in another embodiment, the wheel shaft 12 may be connected to the first transmission unit 70, and the differential shaft 11 may be connected to the second transmission unit 80.

In the above-described embodiment, the clutch device 10 is provided outside the axle case 16. In contrast, in another embodiment, the clutch device 10 may be provided inside the axle case 16.

In the above-described embodiment, an example is described in which the clutch device 10 is provided between the differential shaft 11 and the wheel shaft 12, and transmission of torque between the differential shaft 11 and the wheel shaft 12 is controlled. On the other hand, in another embodiment, for example, the clutch device 10 may be applied such that the first gear shaft 3 is divided into two parts between the motor generator 2 and the first small-diameter gear 5, one part is connected to the first transmission unit 70, and the other part is connected to the second transmission unit 80. In this case, transmission of torque between the motor generator 2 and the first small-diameter gear 5 can be controlled by the clutch device 10.

In another embodiment, for example, the clutch device 10 may be applied such that the second gear shaft 4 is divided into two parts between the first large-diameter gear 6 and the second small-diameter gear 7, one part is connected to the first transmission unit 70, and the other part is connected to the second transmission unit 80. In this case, transmission of torque between the first large-diameter gear 6 and the second small-diameter gear 7 can be controlled by the clutch device 10.

In the above-described embodiment, an example is described in which the clutch device is used to control transmission of torque between the motor generator and the rear wheels of the vehicle. In contrast, in another embodiment, the clutch device may be used to control transmission of torque between the motor generator and front wheels of the vehicle.

The present disclosure is not limited to an electric vehicle, and may be applied to a vehicle, a hybrid vehicle, or the like that travels by a drive torque from an internal combustion engine.

As described above, the present disclosure is not limited to the above-described embodiments and can be implemented in various forms without departing from the scope of the disclosure.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A clutch device comprising:
an electric actuator unit including
a rotary electric motor,
a rotational translation unit configured to convert rotational motion caused by torque from the rotary electric motor into translational motion, and
a fork configured to be translated by the translational motion of the rotational translation unit;
a clutch unit including
a first transmission unit,
a second transmission unit rotatable relative to the first transmission unit, and
a dog clutch configured to translate with translation of the fork and mesh with the first transmission unit to allow transmission of torque between the first transmission unit and the second transmission unit; and
a control unit configured to control operations of the rotary electric motor and the electric actuator unit by controlling energization of the rotary electric motor, wherein
the rotational translation unit includes
a shaft configured to rotate when receiving torque from the rotary electric motor, and
a nut having an annular or tubular shape, provided radially outward of the shaft, and configured to translate in an axial direction relative to the shaft in accordance with rotation of the shaft,
the fork includes
a fork base having an annular or tubular shape, provided radially outward of the nut, and movable in the axial direction relative to the nut, and
a movement restriction portion configured to restrict relative movement of the fork base in the axial direction relative to the nut by the movement restriction portion contacting the nut,
the electric actuator unit includes a spring provided between the nut and the fork base and configured to bias the fork base in the axial direction relative to the nut,
the control unit is configured to control an operation of the rotary electric motor to move the dog clutch to a position where the dog clutch starts to come into contact with the first transmission unit,
a load of the spring is set such that, after the dog clutch and the first transmission unit start to come into contact with each other, the dog clutch and the first transmission unit are meshed with each other under the load of the spring.

2. The clutch device according to claim 1, wherein
a part of the movement restriction portion is provided radially outward of the spring.

3. The clutch device according to any one of claim 1, wherein
the shaft and the spring are coaxially provided.

4. The clutch device according to claim 1, wherein
after the dog clutch and the first transmission unit start to mesh with each other, the control unit is configured to
control an operation of the rotary electric motor to bring the nut into contact with the movement restriction portion,
apply thrust from the rotary electric motor to the dog clutch without passing through the spring, and
move the dog clutch relative to the first transmission unit.

5. The clutch device according to claim 1, wherein
an end portion of the first transmission unit facing the second transmission unit includes a first external spline,
an end portion of the second transmission unit facing the first transmission unit includes a second external spline,
the dog clutch includes a tubular clutch sleeve provided radially outward of the end portion of the second transmission unit facing the first transmission unit and movable in the axial direction relative to the second transmission unit,
the clutch sleeve includes an internal spline configured to mesh with the first external spline when the internal spline moves relative to the second external spline toward the first external spline in the axial direction while the internal spline meshing with the second external spline.
